(19) United States
(12) Patent Application Publication
(10) Pub. No.: US 2025/0081056 A1
(43) Pub. Date: Mar. 6, 2025

(54) DATA COLLECTION TECHNIQUES FOR WIRELESS SYSTEMS

(71) Applicant: Intel Corporation, Santa Clara, CA (US)

(72) Inventors: Ziyi Li, Beijing (CN); Yi Guo, Shanghai (CN); Sudeep Palat, Cheltenham GLS (GB); Bishwarup Mondal, San Ramon, CA (US); Meng Zhang, Beijing (CN)

(73) Assignee: Intel Corporation, Santa Clara, CA (US)

(21) Appl. No.: 18/899,291

(22) Filed: Sep. 27, 2024

(51) Int. Cl. H04W 36/00; H04W 24/10

(52) U.S. Cl. CPC H04W 36/0085; H04W 24/10

(57) ABSTRACT

Embodiments are related to a fifth generation (5G) or sixth generation (6G) wireless communications system. A method for an access node of a wireless system comprises encoding a session start request message to start a data collection session (DCS) to collect data for a machine learning (ML) model from a user equipment (UE) by a base station of a wireless system, the session start request message including UE context information, decoding a session start response message to indicate the start of the DCS by the base station, the session start response message including DCS configuration information for the ML model, and encoding a data collection request message for the UE to collect measurements for the ML model based on the DCS configuration information for the ML model by the base station. Other embodiments are described and claimed.

### CROSS-REFERENCE TO RELATED APPLICATIONS

This application claims the benefit of and priority to previously filed U.S. Provisional Patent Application Ser. No. 63/586,950, filed Sep. 29, 2023, entitled “DATA COLLECTION ENHANCEMENTS FOR AI/ML AIR INTERFACE”, which is hereby incorporated by reference in its entirety.

### BACKGROUND

A wireless communication network, such as Third Generation Partnership Project (3GPP) fifth generation (5G) or the upcoming sixth generation (6G) systems, is a sophisticated infrastructure designed to enable high-speed, reliable, and low-latency data transmission over the airwaves. These networks utilize advanced technologies like millimeter waves, massive Multiple Input Multiple Output (MIMO) antennas, and beamforming to enhance connectivity and capacity. 5G networks, for instance, offer significantly improved data rates and reduced latency compared to previous generations, supporting applications from enhanced mobile broadband to the Internet of Things (IoT). Looking ahead, 6G is expected to push the boundaries further, integrating even more advanced features such as terahertz frequencies, artificial intelligence (AI) driven network management, and seamless integration of virtual and augmented reality, aiming to create an ultra-responsive and hyper-connected digital ecosystem.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates functional framework for an artificial intelligence (AI) and machine learning (ML) system in accordance with one embodiment.

FIG. 2 illustrates a wireless communication system in accordance with one embodiment.

FIG. 3 illustrates a radio access network (RAN) in accordance with one embodiment.

FIG. 4 illustrates a core network (CN) in accordance with one embodiment.

FIG. 5 illustrates a data collection system in accordance with one embodiment.

FIG. 6A illustrates a message flow in accordance with one embodiment.

FIG. 6B illustrates a message flow in accordance with one embodiment.

FIG. 7A illustrates a message flow in accordance with one embodiment.

FIG. 7B illustrates message flow in accordance with one embodiment.

FIG. 8A illustrates a message flow in accordance with one embodiment.

FIG. 8B illustrates a message flow in accordance with one embodiment.

FIG. 9 illustrates a base station in accordance with one embodiment.

FIG. 10 illustrates a logic flow in accordance with one embodiment.

FIG. 11 illustrates a logic flow in accordance with one embodiment.

FIG. 12 illustrates a wireless network in accordance with one embodiment.

FIG. 13 illustrates an apparatus in accordance with one embodiment.

FIG. 14 illustrates a computer readable medium in accordance with one embodiment.

### DETAILED DESCRIPTION

The present disclosure generally relates to wireless technology, and more specifically to artificial intelligence (AI) techniques, procedures and architecture suitable for Fifth Generation (5G) System or Services (5GS) and 5G Core Network (5GC) network functions (NFs), as well as Sixth Generation (6G) System or Services (6GS) and 6G Core Network (6GC) NFs. Although some embodiments are described in the context of a 5GS, the embodiments may also be implemented in a 6GS as well. Embodiments are not limited in this context.

The AI/ML architecture as described herein may be related to one or more wireless standards. For example, embodiments may be suitable for implementation as part of the Third Generation Partnership Project (3GPP) Technical Report (TR) 38.843 titled “Technical Specification Group Radio Access Network; Study on Artificial Intelligence (AI)/Machine Learning (ML) for NR air interface (Release 18), Version 18.0.0 (2023-12); Technical Standard (TS) 38.300 titled “Technical Specification Group Radio Access Network; NR; NR and NG-RAN Overall Description; Stage 2 (Release 18),” Version 18.2.0 (2024-07); TS 37.320 titled “Technical Specification Group Radio Access Network; Radio measurement collection for Minimization of Drive Tests (MDT); Overall description; Stage 2 (Release 18),” Version 18.2.0 (2024-07); TS 38.314 titled “Technical Specification Group Radio Access Network; NR; Layer 2 Measurements; (Release 18),” Version 18.0.0 (2024-03); TS 38.331 titled “Technical Specification Group Radio Access Network; NR; Radio Resource Control (RRC) protocol specification (Release 18),” Version 18.2.0 (2024-07); and any progeny, revisions and variants. Embodiments may be suitable for other 3GPP and non-3GPP wireless standards. Embodiments are not limited to these examples.

Wireless systems are increasingly moving towards artificial intelligence (AI) driven network management. In particular, use cases for AI and machine learning (ML) (AI/ML) over an air interface (e.g., an NR air interface) are currently being studied in 3GPP RAN1 and RAN2, including channel state information (CSI) feedback, beam management, positioning accuracy enhancement, and other network tasks. Embodiments support collecting AI/ML related data useful for various network tasks such as ML model training, ML model inference, ML model monitoring, ML model performance, ML model management, and other network tasks. The collected data could be immediate real-time data or non-real-time data. Furthermore, to collect data specifically for a given ML model operating under different scenarios, embodiments use context information associated with a ML model, user equipment (UE), and/or a base station (e.g., a gNB) to better guide data collection procedures, operations, and activities.

Embodiments are generally directed to a comprehensive data collection framework for collecting data related to AI/ML models and/or AI/ML functionalities used in a 5G and/or 6G wireless communication system. Some embodiments are particularly directed to a data collection framework that addresses new use cases for collecting training data, such as collecting training data for a training dataset, mapping training data to a collection scenario, implementing priority rules, reducing latency, implementing buffering mechanisms, defining reporting structures, specifying storage structures and indexing, creating data objects such as measurement objects and data collection session objects, defining data collection messages, defining information elements (IE) for messages or protocols, and so forth. Embodiments are not limited to these examples.

In some embodiments, the data collection framework extends or enhances a Minimization of Drive Tests (MDT) framework for AI/ML data collection in a 5G and/or 6G wireless communication system. MDT represents a significant advancement in how network performance is monitored and optimized, moving away from traditional physical drive tests that involved using specialized equipment in vehicles to gather data. This conventional method, while effective, was labor-intensive, costly, and time-consuming. MDT transforms this approach by harnessing data collected directly from user devices such as smartphones and tablets, which continuously measure and record key network parameters like signal strength and quality. This data is then periodically or based on specific events reported back to network operators, providing a broad and real-time view of network performance.

The shift to MDT brings notable efficiencies. By relying on user device data, it reduces the need for physical drive tests, leading to significant savings in both time and cost. Network operators gain access to real-time or near real-time data (e.g., milliseconds or microseconds), allowing for swift identification and resolution of issues that affect user experience. This continuous data collection enables more precise and informed network optimization, enhancing overall network quality and operational efficiency while also reducing expenses associated with traditional testing methods.

In advanced wireless systems, such as 5G and 6G systems, MDT is expected to advance further with enhanced analytics capabilities. The integration of AI and ML will allow for deeper and more predictive analysis of the data, helping to foresee and address potential network issues before they escalate. With anticipated increase in device connectivity and data traffic for 6G systems, MDT will handle larger volumes of data, requiring more sophisticated data management and analysis techniques. These advancements will improve the accuracy of performance assessments and provide even more reliable insights for optimizing network performance and enhancing user satisfaction. Thus, MDT not only reduces the need for traditional testing but also adapts to future technological advancements, making network management more effective and efficient.

Embodiments include improved data collection techniques for AI/ML models and/or AI/ML functionalities to enhance an MDT framework for 5G and 6G wireless systems. Some embodiments comprise techniques for automatically collecting AI/ML related data, such as training data for various AI/ML models, from user equipment (UE) by various network devices and/or entities, such as a base station (e.g., a gNodeB or gNB), a core network (CN) network node, a network function (NF) operating on a network slice of a network node of the CN, a management node such as an Operations, Administration, and Maintenance (OAM) network node (or NF), and other network devices or entities. The collected AI/ML related data may be used for AI/ML related tasks such as ML model training, ML model inference, ML model monitoring, ML model performance, ML model management, and other network tasks.

In some embodiments, for example, when model training and/or model inference functions are located at a gNB, the gNB may initiate a data collection session to support model training and/or model inference at the gNB side. The trained ML models may be deployed by the gNB to support various network tasks, such as Channel State Information (CSI), Beam Management (BM) and positioning functions for a network. Additionally, or alternatively, an OAM network node may be responsible for model training for a gNB, and it then deploys the trained model to the gNB. In various embodiments, the gNB and/or the OAM network node may initiate a set of procedures to manage a new type of session, referred to as a “data collection session”, that is specifically designed to collect AI/ML related data from one or more UEs based on, at least in part, UE capability information. In some embodiments, a data collection session refers to a connection established between a UE and a wireless network device, such as a 3GPP network device, including a 5G or 6G base station, core network (CN) node or managing node (e.g., OAM node), allowing data to flow between the UE and the 3GPP network for purposes of collecting AI/ML related data for various AI/ML tasks, such as model training, model deployment, model inferencing, model management, and other AI/ML tasks.

More particularly, embodiments enhance an MDT framework by defining a set of procedures for managing a data collection session between a base station and a UE. Management of a data collection session includes, at least in part, a defined set of procedures, operations, and/or messages for configuration, activation, data collection, and deactivation of the data collection session. Non-limiting examples for activation of a data collection session include both signal-based activation and management-based activation. In some embodiments, signal-based activation is configured by an OAM network node and activated (initiated or triggered) by a base station (e.g., a gNB) or a CN node to start a data collection session between the base station and one or more UEs within transmission range of the base station. In some embodiments, management-based activation is configured by an OAM network node and activated (initiated or triggered) by the OAM network node to start a data collection session between a base station and one or more UEs within transmission range of the base station.

In some embodiments, the base station may comprise a gNB having a split architecture. For example, a gNB may have a configuration or network topology where the gNB is divided into two physical entities, such as a central unit (CU) (gNB-CU) and a distributed unit (DU) (gNB-DU). In such cases, either the gNB-CU or gNB-DU may perform an activation procedure for a data collection session with a UE.

Various network functions, nodes, or devices may configure and activate a new data collection session for a network. In some embodiments, a base station such as a gNB, or parts of a gNB in cases of a split architecture, may initiate a data collection session between the gNB and a UE using an access stratum (AS) protocol layer. In some embodiments, an OAM network node may initiate a data collection session between a gNB and a UE using the AS protocol layer. In some embodiments, a core network (CN) node such as an Access and Mobility Management Function (AMF) or a Location Management Function (LMF), among others, may initiate a data collection session between the CN and a UE via a base station using a non-access-stratum (NAS) protocol layer. Embodiments are not limited to these examples.

During a data collection session, a new connection is formed between the gNB and UE specifically for purposes of data collection. Additionally, or alternatively, a data collection session may use an existing connection for a different session (e.g., management session, handover session, measurement session, etc.). The gNB and the UE may exchange various types of information, such as configuration information defining a type of information to be collected by the UE, configuration information for an AI/ML model for which the data is to be collected, UE capability information, parameters associated with a data connection session (e.g., session activation, session deactivation, session period, session duration, etc.), context information for a UE and/or base station associated with a data collection session (e.g., UE capability information, gNB capability information, gNB workloads, number of UEs, handover operations, signal strength, MIMO settings, etc.), and other types of configuration information. The UE then collects data during the data collection session, such as measuring one or more radio-frequency (RF) signals using a measurement object, and it sends the collected data to the gNB. The gNB may use the collected data for AI/ML related tasks implemented by the gNB.

Additionally, or alternatively, the gNB may forward the collected data to the OAM network node for AI/ML related tasks managed by the OAM, such as training and deploying ML models to various network nodes, such as the gNB. An OAM plays an increasingly important role in managing network operations, particularly advanced network operations such as AI/ML management for a 5G or 6G network. Generally, OAM refers to the suite of functions and processes used to manage and oversee network operation, ensure its optimal performance, and troubleshoot issues. OAM encompasses various tasks, including network monitoring, configuration management, fault management, and performance optimization. These functions are crucial for maintaining the reliability and efficiency of the network, which supports diverse applications and a large number of connected devices. Advanced OAM tools help network operators handle the complexities of new technologies, such as network slicing and virtualization, to ensure seamless service delivery and effective resource utilization. OAM functions are performed by specialized network management systems (NMS) and associated tools. These devices and systems are designed to handle the complex tasks associated with managing and maintaining the network. Operations involves the day-to-day activities necessary to keep the network running efficiently. It includes monitoring network performance, managing resources, and handling network faults. For 5G and 6G networks, which are more complex due to their use of new technologies like network slicing, beamforming, and ultra-dense small cells, operations also involve managing these new elements and ensuring they work together seamlessly. Administration encompasses the configuration and management of network components and services. This includes tasks such as provisioning network slices, configuring parameters for various network functions, such as the User Plane (UP) Function and Control Plane (CP) Function, and managing subscriber information. Administration ensures that network resources are allocated effectively and that services are tailored to meet the specific needs of different use cases, such as enhanced mobile broadband or massive IoT. Maintenance involves the upkeep and troubleshooting of the network to ensure its reliability and performance. This includes detecting and diagnosing faults, performing repairs or updates, and optimizing network performance. In a 5G context, maintenance is crucial due to the increased complexity and dynamic nature of the network, which may involve managing issues related to network slicing, integrating new technologies, or dealing with increased traffic loads.

Various embodiments implement different techniques for managing data collection to support AI/ML related tasks for a 5G and/or 6G network. One embodiment, for example, comprises techniques whereby the gNB initiates data collection session activation for signaling based and management based data collection. One embodiment, for example, comprises techniques whereby the OAM configures a set of assistance information, applicable conditions, and/or use cases for AI/ML data collection, where data collection configuration and assistance information are configured to UE via gNB. One embodiment, for example, comprises techniques whereby the gNB provides a target set of assistance information, applicable conditions, and/or use cases for AI/ML data collection, requesting session setup for the required data collection. One embodiment, for example, comprises techniques whereby the configuration includes a logging duration of collected data discontinuously. One embodiment, for example, comprises techniques whereby the UE indicates its capability of supporting certain applicable scenarios and/or use cases as part of UE capability or UE assistance information (UAI). One embodiment, for example, comprises techniques whereby the configuration includes the corresponding effective radio resource control (RRC) state. One embodiment, for example, comprises techniques whereby a UE collects data in the form of measurements and reports the measurements in a measurement report that includes timestamps, a duration of collection, a condition, assistance information together with the reported data. One embodiment, for example, comprises techniques whereby a gNB sets up a data collection session terminated at a gNB. One embodiment, for example, comprises techniques whereby assistance information and/or applicable conditions are configured as measurement objects or a new 3GP defined object. One embodiment, for example, comprises techniques whereby a new machine type communication (MTC) is considered to configure measurement time duration for AI/ML data collection. One embodiment, for example, comprises techniques whereby the gNB configures applicable conditions or scenarios as a trigger event, and the UE can report buffered data to the gNB when an operating environment is changed. One embodiment, for example, comprises techniques whereby the gNB configures a timer as a trigger event, and the UE can report buffered data to the gNB when the timer expires. One embodiment, for example, comprises techniques whereby the gNB configures buffer threshold as a trigger event, and the UE can report buffered data to the gNB when the buffer is full. One embodiment, for example, comprises techniques whereby the gNB configures quality as a trigger event, and the UE can report buffered data to the gNB when the data meets a defined quality threshold. One embodiment, for example, comprises techniques for collecting AI/ML data from a UE to a location management function (LMF) network node (or NF) for model training/model inference and model monitoring purpose. Embodiments are not limited to these examples. Other embodiments are described and claimed.

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

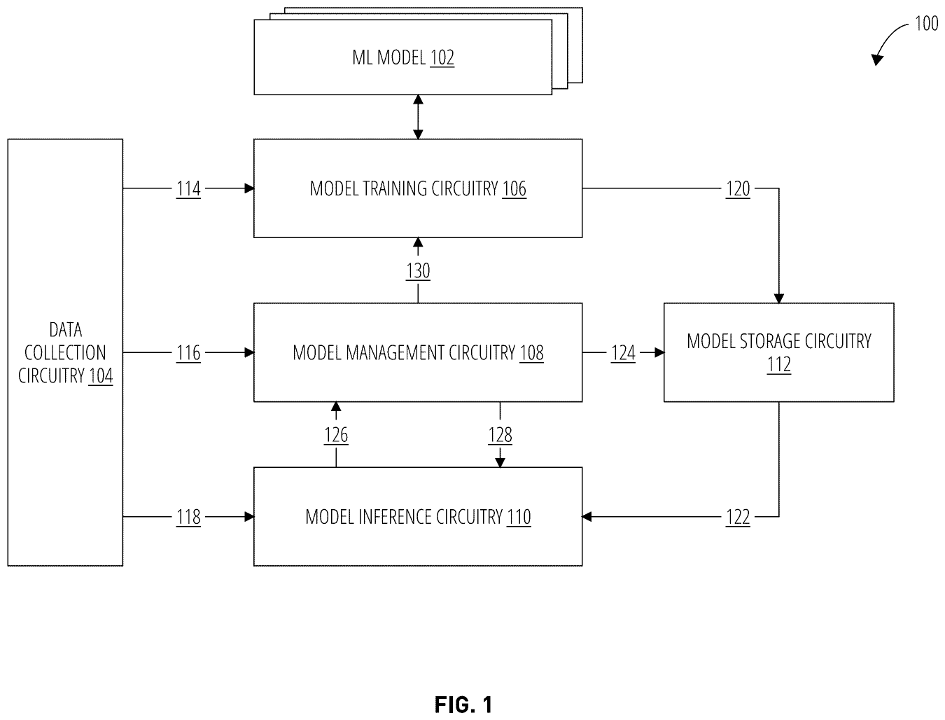

FIG. 1 illustrates a functional framework 100. The functional framework 100 is an example of an AI/ML framework or architecture for a wireless network. The functional framework 100 covers a general functional architecture addressing both model-ID-based life cycle management (LCM) and functionality-based LCM. Therefore, some of the functions or data flows, information flows, or instruction flows (e.g., indicated by arrows) shown in FIG. 1 might not always be relevant for a given LCM approach. As an illustrative example, consider a scenario where the network performs functionality-based LCM and where models are not identified in the network, while the UE concurrently performs model-level management (e.g., model selection, model switching, model activation, model deactivation, etc.). In this case, the “Model Training” or “Model Storage” functions with their respective procedures, may be regarded as less relevant from a network perspective.

As seen in FIG. 1, the functional framework 100 comprises various types of specialized circuitry, such as a data collection circuitry 104, a model training circuitry 106, a model management circuitry 108, a model inference circuitry 110, and a model storage circuitry 112. The functional framework 100 may use circuitry, such as processing circuitry, to execute a set of functions for a network entity, such as a UE, a base station, a NF of a core network, an OAM, and other network devices or network nodes. The functions may be implemented as circuits, such as an application specific integrated circuit (ASIC) or field programmable gate array (FPGA). The functions may also be implemented as program instructions stored in memory that when executed by processing circuitry causes the processing circuitry to perform the functions. Embodiments are not limited in this context.

The data collection circuitry 104 performs a function that provides input data to the model training circuitry 106, model management circuitry 108, and model inference circuitry 110 functions. The data collection circuitry 104 collects and forwards different types of data, such as training data 114 needed as input for the model training circuitry 106, monitoring data 116 needed as input for the model management circuitry 108 to manage a trained ML model 120 or AI/ML functionalities of the trained ML model 120, and inference data 118 needed as input for the model inference circuitry 110.

The model training circuitry 106 executes a function that performs AI/ML model training, validation, and testing for one or more ML models 102, which may also generate model performance metrics which can be used as part of the model testing procedure. The model training circuitry 106 is also responsible for data preparation (e.g., data pre-processing and cleaning, formatting, and transformation) based on training data 114 delivered by the data collection circuitry 104.

The model training circuitry 106 trains an ML model 102 and it outputs a trained ML model 120. The model training circuitry 106 delivers trained, validated, and tested trained ML model 120 to the model storage circuitry 112. Additionally, or alternatively, the model training circuitry 106 delivers an updated version of a trained ML model 120 to the model storage circuitry 112.

The model management circuitry 108 executes a function that oversees the operation (e.g., selection/(de)activation/switching/fallback) and monitoring (e.g., performance) of trained ML models 120 or AI/ML functionalities. The model management circuitry 108 is also responsible for making decisions to ensure the proper inference operation based on data received from the data collection circuitry 104 and the model inference circuitry 110.

The model management circuitry 108 may generate and forward management instructions 128 to the model inference circuitry 110. A management instruction 128 comprises information needed as input to manage the model inference circuitry 110. The information may include selection, activation, deactivation, or switching of trained ML models 120 or AI/ML-based functionalities, fallback to non-AI/ML operation (e.g., not relying on inference process), and other management operations.

The model management circuitry 108 may also generate and forward a model request 124 to the model storage circuitry 112. The model request 124 comprises information such as a model transfer request, a model delivery request, and other management instructions for the model storage circuitry 112.

The model management circuitry 108 may also generate and forward feedback 130 to the model training circuitry 106. The feedback 130 comprises information needed as input for the model training circuitry 106, such as performance feedback, retraining requests, updating requests, reinforcement learning, and so forth.

The model inference circuitry 110 executes a function that provides outputs from the process of applying trained ML models 120 or AI/ML functionalities, using the inference data 118 provided by the data collection circuitry 104 as an input. The model inference circuitry 110 is also responsible for data preparation (e.g., data pre-processing and cleaning, formatting, and transformation) based on the inference data 118 delivered by the data collection circuitry 104. The model inference circuitry 110 receives the inference data 118 as input, analyzes the inference data 118, and it generates an inference output 126. The inference output 126 may be delivered to various circuitry executing functions for any number of downstream tasks for a 5G or 6G wireless system. The model inference circuitry 110 may also deliver the inference output 126 to the model management circuitry 108 to monitor the performance of the trained ML models 120 or AI/ML functionalities.

The model storage circuitry 112 executes a function responsible for storing trained ML models 120 that can be used to perform an inference function by the model inference circuitry 110. It is worthy to note that the model storage circuitry 112 in FIG. 1 is only intended as a reference point (if any) when applicable for protocol terminations, model transfer/delivery, and related processes. It should be stressed that its purpose does not encompass restricting the actual storage locations of models. Therefore, the specification impact of all data/information/instruction flows (i.e., the arrows in FIG. 1) to/from this function may vary for a given implementation. The model storage circuitry 112 may be used to deliver a trained ML model 120 to the model inference circuitry 110.

The functional framework 100 may be implemented for various use cases for a 5G or 6G wireless network. Non-limiting examples of use cases include: (1) CSI feedback enhancement, e.g., overhead reduction, improved accuracy, prediction [RAN1 or RAN2]; (2) beam management, e.g., beam prediction in time, and/or spatial domain for overhead and latency reduction, beam selection accuracy improvement [RAN1 or RAN2]; and/or (3) positioning accuracy enhancements for different scenarios including, e.g., those with heavy NLOS conditions [RAN1 or RAN2]. A particular use case for the functional framework 100 may be determined for a given implementation. However, the functional framework 100 provides a robust AI/ML architecture for a variety of sub use cases and is diverse enough to support various requirements on a variety of gNB-UE collaboration levels.

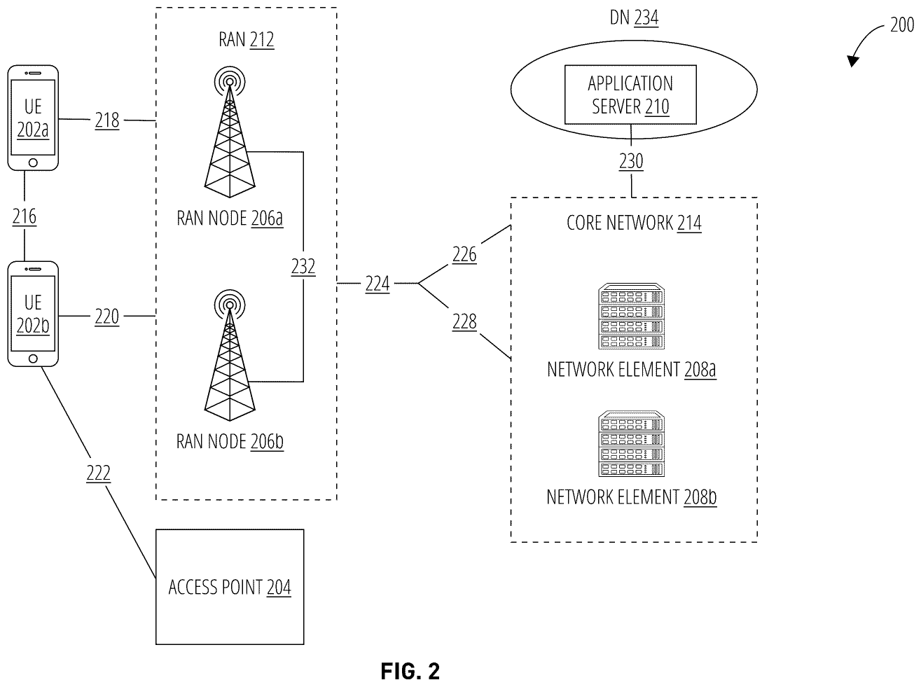

FIG. 2 illustrates an example of a wireless communication system 200. For purposes of convenience and without limitation, the example wireless communication system 200 is described in the context of the long-term evolution (LTE) and fifth generation (5G) new radio (NR) (5G NR) cellular networks communication standards as defined by one or more 3GPP technical specifications (TSs) and/or technical reports (TRs), as previously identified. However, other types of wireless standards are possible.

The wireless communication system 200 includes UE 202a and UE 202b (collectively referred to as the “UEs 202”). In this example, the UEs 202 are illustrated as smartphones (e.g., handheld touchscreen mobile computing devices connectable to one or more cellular networks). In other examples, any of the can include other mobile or non-mobile computing devices, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M) devices, Internet of Things (IoT) devices, or combinations of them, among others.

In some implementations, any of the UEs 202 may be IoT UEs, which can include a network access layer designed for low-power IoT applications utilizing short-lived UE connections. An IoT UE can utilize technologies such as M2M or MTC for exchanging data with an MTC server or device using, for example, a public land mobile network (PLMN), proximity services (ProSe), device-to-device (D2D) communication, sensor networks, IoT networks, or combinations of them, among others. The M2M or MTC exchange of data may be a machine-initiated exchange of data. An IoT network describes interconnecting IoT UEs, which can include uniquely identifiable embedded computing devices (within the Internet infrastructure), with short-lived connections. The IoT UEs may execute background applications (e.g., keep-alive messages or status updates) to facilitate the connections of the IoT network.

The UEs 202 are configured to connect (e.g., communicatively couple) with a radio access network (RAN) 212. In some implementations, the RAN 212 may be a next generation RAN (NG RAN), an evolved UMTS terrestrial radio access network (E-UTRAN), or a legacy RAN, such as a UMTS terrestrial radio access network (UTRAN) or a GSM EDGE radio access network (GERAN). As used herein, the term “NG RAN” may refer to a RAN 212 that operates in a 5G NR wireless communication system 200, and the term “E-UTRAN” may refer to a RAN 212 that operates in an LTE or 4G wireless communication system 200.

To connect to the RAN 212, the utilize connections (or channels) 218 and 220, respectively, each of which can include a physical communications interface or layer, as described below. In this example, the connections 218 and 220 are illustrated as an air interface to enable communicative coupling, and can be consistent with cellular communications protocols, such as a global system for mobile communications (GSM) protocol, a code-division multiple access (CDMA) network protocol, a push-to-talk (PTT) protocol, a PTT over cellular (POC) protocol, a universal mobile telecommunications system (UMTS) protocol, a 3GPP LTE protocol, a 5G NR protocol, or combinations of them, among other communication protocols.

The UE 202b is shown to be configured to access an access point (AP) 204 (also referred to as “WLAN node 204,” “WLAN 204,” “WLAN Termination 204,” “WT 204” or the like) using a connection 222. The connection 222 can include a local wireless connection, such as a connection consistent with any IEEE 802.11 protocol, in which the AP 204 would include a wireless fidelity (Wi-Fi) router. In this example, the AP 204 is shown to be connected to the Internet without connecting to the core network of the wireless system, as described in further detail below.

The RAN 212 can include one or more nodes such as RAN nodes 206a and 206b (collectively referred to as “RAN nodes 106” or “RAN node 106”) that enable the connections 218 and 220. The RAN nodes 206 may comprise access nodes for the UE 202 to access the RAN 212 and infrastructure equipment such as core network 214. As used herein, the terms “access node,” “access point,” or the like may describe equipment that provides the radio baseband functions for data or voice connectivity, or both, between a network and one or more users. An access node may terminate air-interface protocols for a UE by providing access stratum protocols including radio resource control (RRC), Packet Data Convergence Protocol (PDCP), radio link control (RLC), medium access control (MAC), and layer 1 (L1) protocols. In this manner, an access node may enable data/voice connectivity between CN 214 and the UE 202. In some embodiments, the access node may be implemented in a discrete device or as one or more software entities running on server computers as part of, for example, a virtual network, which may be referred to as a CRAN or virtual baseband unit pool. These access nodes can be referred to as base stations (BS), gNodeBs, gNBs, eNodeBs, eNBs, NodeBs, RAN nodes, rode side units (RSUs), transmission reception points (TRxPs or TRPs), and the link, and can include ground stations (e.g., terrestrial access points) or satellite stations providing coverage within a geographic area (e.g., a cell), among others. As used herein, the term “NG RAN node” may refer to a RAN node 206 that operates in an 5G NR wireless communication system 200 (for example, a gNB), and the term “E-UTRAN node” may refer to a RAN node 106 that operates in an LTE or 4G wireless communication system 200 (e.g., an eNB). In some implementations, the RAN nodes 206 may be implemented as one or more of a dedicated physical device such as a macrocell base station, or a low power (LP) base station for providing femtocells, picocells or other like cells having smaller coverage areas, smaller user capacity, or higher bandwidth compared to macrocells.

In some implementations, some or all of the RAN nodes 106 may be implemented as one or more software entities running on server computers as part of a virtual network, which may be referred to as a cloud RAN (CRAN) or a virtual baseband unit pool (vBBUP). The CRAN or vBBUP may implement a RAN function split, such as a packet data convergence protocol (PDCP) split in which radio resource control (RRC) and PDCP layers are operated by the CRAN/vBBUP and other layer two (e.g., data link layer) protocol entities are operated by individual RAN nodes 106; a medium access control (MAC)/physical layer (PHY) split in which RRC, PDCP, MAC, and radio link control (RLC) layers are operated by the CRAN/vBBUP and the PHY layer is operated by individual RAN nodes 106; or a “lower PHY” split in which RRC, PDCP, RLC, and MAC layers and upper portions of the PHY layer are operated by the CRAN/vBBUP and lower portions of the PHY layer are operated by individual RAN nodes 106. This virtualized framework allows the freed-up processor cores of the RAN nodes 106 to perform, for example, other virtualized applications. In some implementations, an individual RAN node 106 may represent individual gNB distributed units (DUs) that are connected to a gNB central unit (CU) using individual F1 interfaces (not shown in FIG. 2). In some implementations, the gNB-DUs can include one or more remote radio heads or RFEMs, and the gNB-CU may be operated by a server that is located in the RAN 112 (not shown) or by a server pool in a similar manner as the CRAN/vBBUP. Additionally, or alternatively, one or more of the RAN nodes 106 may be next generation eNBs (ng-eNBs), including RAN nodes that provide E-UTRA user plane and control plane protocol terminations toward the, and are connected to a 5G core network (e.g., CN 214) using a next generation interface.

In vehicle-to-everything (V2X) scenarios, one or more of the RAN nodes 106 may be or act as RSUs. The term “Road Side Unit” or “RSU” refers to any transportation infrastructure entity used for V2X communications. A RSU may be implemented in or by a suitable RAN node or a stationary (or relatively stationary) UE, where a RSU implemented in or by a UE may be referred to as a “UE-type RSU,” a RSU implemented in or by an eNB may be referred to as an “eNB-type RSU,” a RSU implemented in or by a gNB may be referred to as a “gNB-type RSU,” and the like. In some implementations, an RSU is a computing device coupled with radio frequency circuitry located on a roadside that provides connectivity support to passing vehicle (v). The RSU may also include internal data storage circuitry to store intersection map geometry, traffic statistics, media, as well as applications or other software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) or provide connectivity to one or more cellular networks to provide uplink and downlink communications, or both. The computing device(s) and some or all of the radio-frequency circuitry of the RSU may be packaged in a weatherproof enclosure suitable for outdoor installation, and can include a network interface controller to provide a wired connection (e.g., Ethernet) to a traffic signal controller or a backhaul network, or both.

Any of the RAN nodes 106 can terminate the air interface protocol and can be the first point of contact for the. In some implementations, any of the RAN nodes 106 can fulfill various logical functions for the RAN 212 including, but not limited to, radio network controller (RNC) functions such as radio bearer management, uplink and downlink dynamic radio resource management and data packet scheduling, and mobility management.

In some implementations, the can be configured to communicate using orthogonal frequency division multiplexing (OFDM) communication signals with each other or with any of the RAN nodes 106 over a multicarrier communication channel in accordance with various communication techniques, such as, but not limited to, OFDMA communication techniques (e.g., for downlink communications) or SC-FDMA communication techniques (e.g., for uplink communications), although the scope of the techniques described here not limited in this respect. The OFDM signals can comprise a plurality of orthogonal subcarriers.

The RAN nodes 106 can transmit to the over various channels. Various examples of downlink communication channels include Physical Broadcast Channel (PBCH), Physical Downlink Control Channel (PDCCH), and Physical Downlink Shared Channel (PDSCH). Other types of downlink channels are possible. The can transmit to the RAN nodes 106 over various channels. Various examples of uplink communication channels include Physical Uplink Shared Channel (PUSCH), Physical Uplink Control Channel (PUCCH), and Physical Random Access Channel (PRACH). Other types of uplink channels are possible.

In some implementations, a downlink resource grid can be used for downlink transmissions from any of the RAN nodes 106 to the, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The PDSCH carries user data and higher-layer signaling to the. The PDCCH carries information about the transport format and resource allocations related to the PDSCH channel, among other things. It may also inform the about the transport format, resource allocation, and hybrid automatic repeat request (HARQ) information related to the uplink shared channel. Downlink scheduling (e.g., assigning control and shared channel resource blocks to the UE 202b within a cell) may be performed at any of the RAN nodes 106 based on channel quality information fed back from any of the. The downlink resource assignment information may be sent on the PDCCH used for (e.g., assigned to) each of the.

The PDCCH uses control channel elements (CCEs) to convey the control information. Before being mapped to resource elements, the PDCCH complex-valued symbols may first be organized into quadruplets, which may then be permuted using a sub-block interleaver for rate matching. In some implementations, each PDCCH may be transmitted using one or more of these CCEs, in which each CCE may correspond to nine sets of four physical resource elements collectively referred to as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. In LTE, there can be four or more different PDCCH formats defined with different numbers of CCEs (e.g., aggregation level, L=1, 2, 4, or 8).

Some implementations may use concepts for resource allocation for control channel information that are an extension of the above-described concepts. For example, some implementations may utilize an enhanced PDCCH (EPDCCH) that uses PDSCH resources for control information transmission. The EPDCCH may be transmitted using one or more enhanced CCEs (ECCEs). Similar to above, each ECCE may correspond to nine sets of four physical resource elements collectively referred to as an enhanced REG (EREG). An ECCE may have other numbers of EREGs.

The RAN nodes 106 are configured to communicate with one another using an interface 232. In examples, such as where the wireless communication system 200 is an LTE system (e.g., when the core network (CN) 214 is an evolved packet core (EPC) network), the interface 232 may be an X2 interface 232. The X2 interface may be defined between two or more RAN nodes 106 (e.g., two or more eNBs and the like) that connect to the CN 214, or between two eNBs connecting to CN 214, or both. In some implementations, the X2 interface can include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a master eNB to a secondary eNB; information about successful in sequence delivery of PDCP protocol data units (PDUs) to a UE 202 from a secondary eNB for user data; information of PDCP PDUs that were not delivered to a UE 202; information about a current minimum desired buffer size at the secondary eNB for transmitting to the UE user data, among other information. The X2-C may provide intra-LTE access mobility functionality, including context transfers from source to target eNBs or user plane transport control; load management functionality; inter-cell interference coordination functionality, among other functionalities.

In some implementations, such as where the wireless communication system 200 is a 5G NR system (e.g., when the CN 214 is a 5G core network), the interface 232 may be an Xn interface 232. The Xn interface may be defined between two or more RAN nodes 106 (e.g., two or more gNBs and the like) that connect to the 5G CN 214, between a RAN node 106 (e.g., a gNB) connecting to the 5G CN 214 and an eNB, or between two eNBs connecting to the 5G CN 214, or combinations of them. In some implementations, the Xn interface can include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 202 in a connected mode (e.g., CM-CONNECTED) including functionality to manage the UE mobility for connected mode between one or more RAN nodes 106, among other functionalities. The mobility support can include context transfer from an old (source) serving RAN node 106 to new (target) serving RAN node 106, and control of user plane tunnels between old (source) serving RAN node 106 to new (target) serving RAN node 106. A protocol stack of the Xn-U can include a transport network layer built on Internet Protocol (IP) transport layer, and a GPRS tunneling protocol for user plane (GTP-U) layer on top of a user datagram protocol (UDP) or IP layer(s), or both, to carry user plane PDUs. The Xn-C protocol stack can include an application layer signaling protocol (referred to as Xn Application Protocol (Xn-AP or XnAP)) and a transport network layer (TNL) that is built on a stream control transmission protocol (SCTP). The SCTP may be on top of an IP layer, and may provide the guaranteed delivery of application layer messages. In the transport IP layer, point-to-point transmission is used to deliver the signaling PDUs. In other implementations, the Xn-U protocol stack or the Xn-C protocol stack, or both, may be same or similar to the user plane and/or control plane protocol stack(s) shown and described herein.

The RAN 212 is shown to be communicatively coupled to a CN 214 (referred to as a “CN 214”). The CN 214 includes multiple network elements and/or network functions (NFs), such as network element 208a and network element 208b (collectively referred to as the “network elements 108”), which are configured to offer various data and telecommunications services to customers/subscribers (e.g., users of) who are connected to the CN 214 using the RAN 212. The components of the CN 214 may be implemented in one physical node or separate physical nodes and can include components to read and execute instructions from a machine-readable or computer-readable medium (e.g., a non-transitory machine-readable storage medium). In some implementations, network functions virtualization (NFV) may be used to virtualize some or all of the network node functions described here using executable instructions stored in one or more computer-readable storage mediums, as described in further detail below. A logical instantiation of the CN 214 may be referred to as a network slice, and a logical instantiation of a portion of the CN 214 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more network components or functions, or both.

In some implementations, the CN 214 may be a 5G core network (referred to as “5GC CN 214” or “5G CN 214”), and the RAN 212 may be connected with the CN 214 using a next generation interface 224. In some implementations, the next generation interface 224 may be split into two parts, a next generation user plane (NG-U) interface 228, which carries traffic data between the RAN nodes 106 and a user plane function (UPF), and the S1 control plane (NG-C) interface 226, which is a signaling interface between the RAN nodes 106 and access and mobility management functions (AMFs). Examples where the CN 214 is a 5G core network are discussed in more detail with regard to later figures.

In some implementations, the CN 214 may be an evolved packet core (EPC) (referred to as “EPC CN 214” or the like), and the RAN 212 may be connected with the CN 214 using an S1 interface 224. In some implementations, the S1 interface 224 may be split into two parts, an S1 user plane (S1-U) interface 228, which carries traffic data between the RAN nodes 106 and the serving gateway (S-GW), and the S1-MME interface 226, which is a signaling interface between the RAN nodes 106 and mobility management entities (MMEs).

The CN 214 may include MME, SGW, SGSN, HSS, PGW, PCRF, and/or other NFs coupled with one another over various interfaces (or “reference points”) (not shown). The CN 114 may be a 5GC including an AUSF, AMF, SMF, UPF, NSSF, NEF, NRF, PCF, UDM, AF, and/or other NFs coupled with one another over various service-based interfaces and/or reference points. The 5GC may enable edge computing by selecting operator/3rd party services to be geographically close to a point that the UE 202 is attached to the network. This may reduce latency and load on the network. In edge computing implementations, the 5GC may select a UPF close to the UE 202 and execute traffic steering from the UPF to a data network (DN) 234 via an N6 interface. This may be based on the UE subscription data, UE location, and information provided by the AF, which allows the AF to influence UPF (re)selection and traffic routing.

The DN 234 may represent various network operator services, Internet access, or third party services that may be provided by one or more servers including, for example, the application server 210. The application server 210 may be an element offering applications that use IP bearer resources with the core network (e.g., UMTS packet services (PS) domain, LTE PS data services, among others). The application server 210 can also be configured to support one or more communication services (e.g., VoIP sessions, PTT sessions, group communication sessions, social networking services, among others) for the using the CN 214. The application server 210 can use an IP communications interface 230 to communicate with one or more network element 208a or network element 208b.

The DN 234 may be an operator external public, a private PDN, or an intra-operator packet data network, for example, for provision of IMS services. In this embodiment, the application server 210 can be coupled to an IMS via an S-CSCF or the I-CSCF. In some implementations, the DN 234 may represent one or more local area DNs (LADNs), which are DNs (or DN names (DNNs)) that is/are accessible by a UE 202 in one or more specific areas. Outside of these specific areas, the UE 202 is not able to access the LADN/DN.

Additionally, or alternatively, the DN 234 may be an Edge DN 234, which is a (local) Data Network that supports the architecture for enabling edge applications. In these embodiments, the application server 210 may represent the physical hardware systems/devices providing app server functionality and/or the application software resident in the cloud or at an edge compute node that performs server function(s). In some embodiments, the application server 210 provides an edge hosting environment that provides support required for Edge Application Server's execution.

In some embodiments, the 5GS can use one or more edge compute nodes to provide an interface and offload processing of wireless communication traffic. In these embodiments, the edge compute nodes may be included in, or co-located with one or more RAN 212. For example, the edge compute nodes can provide a connection between the RAN 212 and UPF in the 5GC. The edge compute nodes can use one or more NFV instances instantiated on virtualization infrastructure within the edge compute nodes to process wireless connections to and from the RAN 212 and a UPF.

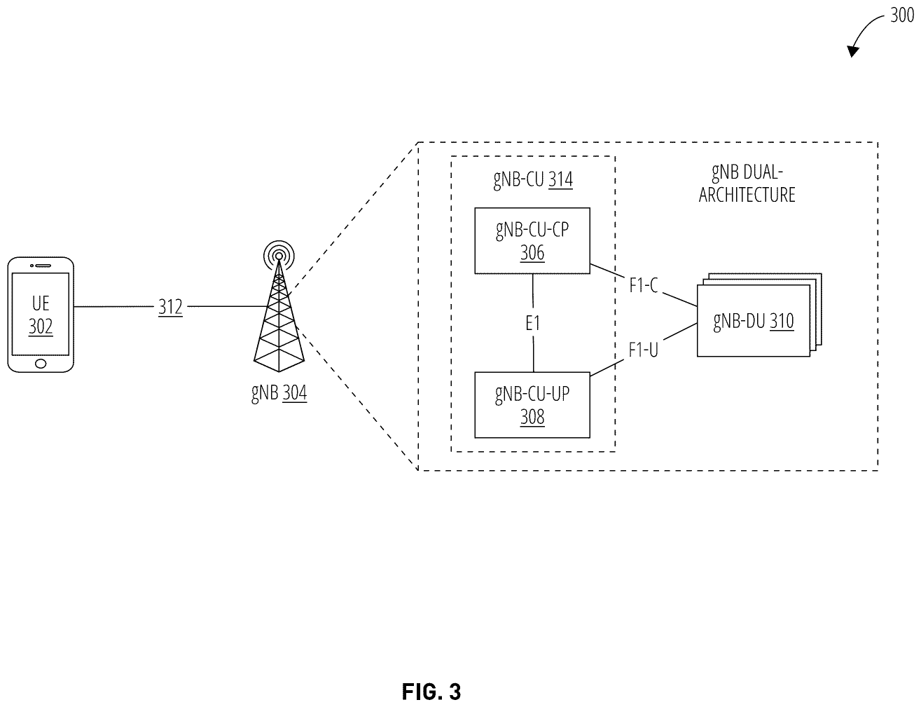

FIG. 3 illustrates a wireless communication system 300. The wireless communication system 300 is a sub-system of the wireless communication system 200 illustrated in FIG. 2. The wireless communication system 300 depicts a UE 302 connected to a gNB 304 over a connection 312. The UE 302 and connection 312 are similar to the UE 202 and the connections 218, 220 described with reference to FIG. 2. The gNB 304 is similar to the RAN node 106, and represents an implementation of the RAN node 106 as a gNB with a dual-architecture.

As depicted in FIG. 3, the gNB 304 is divided into two physical entities referred to a centralized or central unit (CU) and a distributed unit (DU). The gNB 304 may comprise a gNB-CU 314 and one or more gNB-DU 310. The gNB-CU 314 is further divided into a gNB-CU control plane (gNB-CU-CP) 306 and a gNB-CU user plane (gNB-CU-UP) 308. The gNB-CU-CP 306 and the gNB-CU-UP 308 communicate over an E1 interface. The gNB-CU-CP 306 communicates with one or more gNB-DU 310 over an F1-C interface. The gNB-CU-UP 308 communicates with the one or more gNB-DU 310 over an F1-U interface.

The gNB-CU-CP 306 and the gNB-CU-UP 308 provides support for higher layers of a protocol stack such as Service Data Adaptation Protocol (SDAP), Packet Data Convergence Protocol (PDCP) and RRC. The gNB-DU 310 provides support for lower layers of the protocol stack such as Radio Link Control (RLC), MAC layer, and PHY layer. In some implementations, there is a single gNB-CU 314 for each gNB 304 that controls multiple gNB-DU 310. For example, the gNB 304 may have hundreds of gNB-DU 310 connected to a single gNB-CU 314. Each gNB-DU 310 is able to support one or more cells, where one gNB 304 can potentially control hundreds of cells in a 5G NR system.

As previously discussed, in a 5G NR system, such as defined by 3GPP TS 38.473 and/or TS 28.423, the UE 302 can enter different RRC states, such as an idle state and a connected state. The UE 302 can also enter an inactive state where the UE 302 is registered with the network but not actively transmitting data. A resume procedure can prepare the UE 302 for subsequent data transmission by causing the UE 302 to switch from an inactive state to a connected state. In 5G NR, the RRC states for a 5G NR enabled UE can include RRC IDLE, RRC_INACTIVE, and RRC_CONNECTED states. When not transmitting data in an RRC_CONNECTED state, the UE 302 can switch to an RRC_INACTIVE state but remain registered with the network.

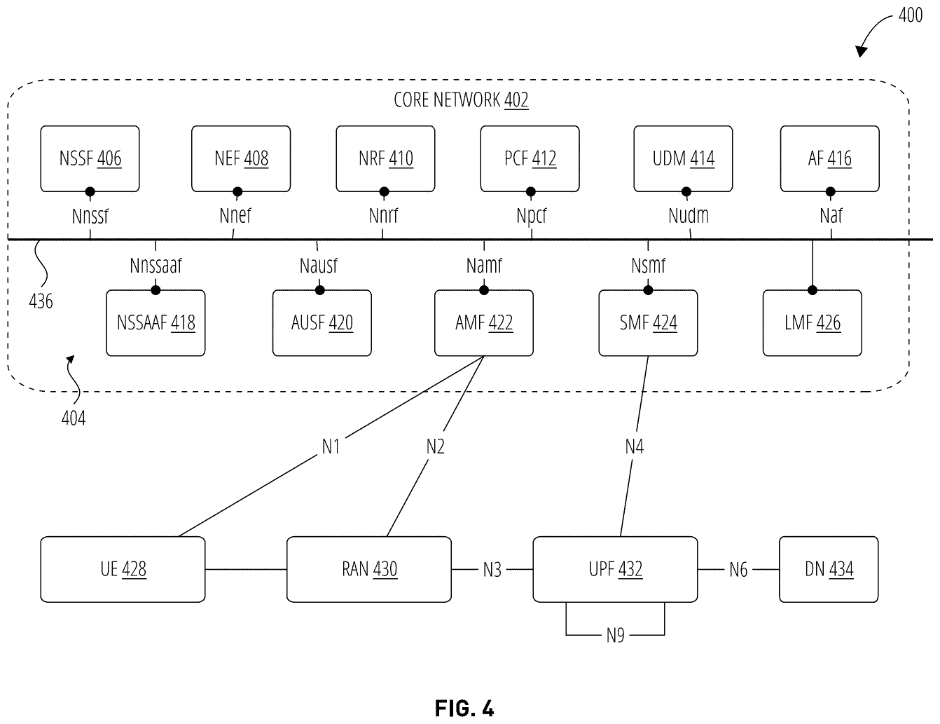

FIG. 4 illustrates a network architecture 400. FIG. 4 illustrates block diagrams of NF components (NFs) and interfaces in connection with embodiments/aspects described herein. In the 5G network architecture of FIG. 4, a next generation (NG) radio access network (RAN) (NG-RAN) comprises a functional split feature that splits a gNodeB (gNB) (also referred to as an “NG RAN,” “NG RAN node,” or the like) into a gNB-Centralized Unit (CU) (gNB-CU) that implements the upper layer of gNB function and gNB-Distributed Unit (DU) (gNB-DU) that implements the lower layer gNB function. The 5G core NFs and gNB-CU can be implemented as Virtualized Network Functions (VNFs), and the gNB-CU and/or gNB-DU can be implemented as Physical Network Function(s) (PNF(s). An Operator can create a virtualized 5G networks by using the European Telecommunications Standards Institute (ETSI) network functions virtualization (NFV) lifecycle management function to instantiate a Network Service (NS) in the cloud that includes various VNFs (e.g., 5G core NFs, gNB-CU), PNFs (e.g. gNB-DU), and VNF Forwarding Graph(s) (VNFFG(s)).

FIG. 4 illustrates an architecture of a network architecture 400 including a second CN 402 in accordance with various embodiments. The network architecture 400 is similar to the wireless communication system 200, and may illustrate equipment, devices and network elements similar to those described with reference to the wireless communication system 200. As depicted in FIG. 4, the network architecture 400 includes a user equipment (UE) 428, a RAN 430 or access node (AN); and a DN 434, which can all be the same or similar to similarly named elements as discussed herein. The DN 434 is the same or similar to the DN 234, and it can implement, for example, operator services, Internet access or 3rd party services, as discussed further below. The CN 214 may be implemented as a 5GC or 5GS, and it can include an Authentication Server Function (AUSF) 420; an AMF 422; an SMF 424; a NEF 408; a PCF 412; an NRF 410; a Unified Data Management (UDM) 414; an application function (AF) 416; an LMF 426; a user plane function (UPF) 432; Network Slice-Specific Authentication and Authorization Function (NSSAAF) 418; and an NSSF 406, each with respective components for processing corresponding 5GC network functions (NFs).

The UPF 432 can act as an anchor point for intra-RAT and inter-RAT mobility, an external protocol data unit (PDU) session point of interconnect to DN 203, and a branching point to support multi-homed PDU session. The UPF 432 can also perform packet routing and forwarding, perform packet inspection, enforce the user plane part of policy rules, lawfully intercept packets (UP collection), perform traffic usage reporting, perform QoS handling for a user plane (e.g., packet filtering, gating, uplink (UL)/downlink (DL) rate enforcement), perform Uplink Traffic verification (e.g., Service Data Flow (SDF) to Quality of Service (QoS) flow mapping), transport level packet marking in the uplink and downlink, and perform downlink packet buffering and downlink data notification triggering. UPF 432 can include an uplink classifier to support routing traffic flows to a data network. The DN 434 can represent various network operator services, Internet access, or third party services. DN 434 can include, or be similar to, application server XQ30 discussed previously. The UPF 432 can interact with the SMF 424 via an N4 reference point between the SMF 424 and the UPF 432.

The AUSF 420 can store data for authentication of UE 302 and handle authentication-related functionality. The AUSF 420 can facilitate a common authentication framework for various access types. The AUSF 420 can communicate with the AMF 422 via an N12 reference point between the AMF 422 and the AUSF 420; and can communicate with the UDM 414 via an N13 reference point between the UDM 414 and the AUSF 420. Additionally, the AUSF 420 can exhibit an Nausf service-based interface.

The AMF 422 can be responsible for registration management (e.g., for registering UE 302, etc.), connection management, reachability management, mobility management, and lawful interception of AMF-related events, and access authentication and authorization. The AMF 422 can be a termination point for an N11 reference point between the AMF 422 and the SMF 424. The AMF 422 can provide transport for SM messages between the UE 302 and the SMF 424, and act as a transparent proxy for routing SM messages. AMF 422 can also provide transport for SMS messages between UE 302 and a Short Message Service (SMS) function (SMSF) (not shown by FIG. 4). AMF 422 can act as Security Anchor Function (SEAF), which can include interaction with the AUSF 420 and the UE 302, receipt of an intermediate key that was established as a result of the UE 302 authentication process. Where Universal Subscriber Identity Module (USIM) based authentication is used, the AMF 422 can retrieve the security material from the AUSF 420. AMF 422 can also include a Security Context Management (SCM) function, which receives a key from the SEAF that it uses to derive access-network specific keys. Furthermore, AMF 422 can be a termination point of a RAN CP interface or RAN connection point interface, which can include or be an N2 reference point between the RAN 430 and the AMF 422; and the AMF 422 can be a termination point of Non Access Stratum (NAS) layer (N1) signaling, and perform NAS ciphering and integrity protection.

AMF 422 can also support NAS signaling with a UE 302 over an N3 Interworking Function (IWF) interface. The N3 IWF can be used to provide access to untrusted entities. N3IWF can be a termination point for the N2 interface between the RAN 430 and the AMF 422 for the control plane, and can be a termination point for the N3 reference point between the RAN 430 and the UPF for the user plane. As such, the AMF 422 can handle N2 signaling from the SMF 424 and the AMF 422 for PDU sessions and QoS, encapsulate/de-encapsulate packets for IPSec and N3 tunneling, mark N3 user-plane packets in the uplink, and enforce QoS corresponding to N3 packet marking considering QoS requirements associated with such marking received over N2. N3IWF can also relay uplink and downlink control-plane NAS signaling between the UE 302 and AMF 422 via an N1 reference point between the UE 302 and the AMF 422, and relay uplink and downlink user-plane packets between the UE 302 and UPF 432. The N3IWF also provides mechanisms for IPsec tunnel establishment with the UE 302. The AMF 422 can exhibit an Namf service-based interface, and can be a termination point for an N14 reference point between two AMFs and an N17 reference point between the AMF 422 and a 5G-Equipment Identity Register (EIR) (not shown by FIG. 4).

The UE 302 can need to register with the AMF 422 in order to receive network services. Registration Management (RM) is used to register or deregister the UE 302 with the network (e.g., AMF 422), and establish a UE context in the network (e.g., AMF 422). The UE 302 can operate in an RM-REGISTERED state or an RM-DEREGISTERED state. In the RM-DEREGISTERED state, the UE 302 is not registered with the network, and the UE context in AMF 422 holds no valid location or routing information for the UE 302 so the UE 302 is not reachable by the AMF 422. In the RM-REGISTERED state, the UE 302 is registered with the network, and the UE context in AMF 422 can hold a valid location or routing information for the UE 302 so the UE 302 is reachable by the AMF 422. In the RM-REGISTERED state, the UE 302 can perform mobility Registration Update procedures, perform periodic Registration Update procedures triggered by expiration of the periodic update timer (e.g., to notify the network that the UE 302 is still active), and perform a Registration Update procedure to update UE capability information or to re-negotiate protocol parameters with the network, among others.

The AMF 422 can store one or more RM contexts for the UE 302, where each RM context is associated with a specific access to the network. The RM context can be a data structure, database object, etc. that indicates or stores, inter alia, a registration state per access type and the periodic update timer. The AMF 422 can also store a 5GC MM context that can be the same or similar to the (E)MM context discussed previously. In various embodiments, the AMF 422 can store a CE mode B Restriction parameter of the UE 302 in an associated MM context or RM context. The AMF 422 can also derive the value, when needed, from the UE's usage setting parameter already stored in the UE context (and/or MM/RM context).

Connection Management (CM) can be used to establish and release a signaling connection between the UE 302 and the AMF 422 over the N1 interface. The signaling connection is used to enable NAS signaling exchange between the UE 302 and the CN 402, and comprises both the signaling connection between the UE and the Access Network (AN) (e.g., Radio Resource Control (RRC) connection or UE-N3IWF connection for non-3GPP access) and the N2 connection for the UE 302 between the AN (e.g., RAN 430) and the AMF 422. The UE 302 can operate in one of two CM states, CM-IDLE mode or CM-CONNECTED mode. When the UE 302 is operating in the CM-IDLE state/mode, the UE 302 can have no NAS signaling connection established with the AMF 221 over the N1 interface, and there can be RAN 430 signaling connection (e.g., N2 and/or N3 connections) for the UE 302. When the UE 302 is operating in the CM-CONNECTED state/mode, the UE 302 can have an established NAS signaling connection with the AMF 422 over the N1 interface, and there can be a RAN 430 signaling connection (e.g., N2 and/or N3 connections) for the UE 302. Establishment of an N2 connection between the RAN 430 and the AMF 422 can cause the UE 302 to transition from CM-IDLE mode to CM-CONNECTED mode, and the UE 302 can transition from the CM-CONNECTED mode to the CM-IDLE mode when N2 signaling between the RAN 430 and the AMF 422 is released.

The SMF 424 can be responsible for SM (e.g., session establishment, modify and release, including tunnel maintain between UPF and AN node); UE IP address allocation and management (including optional authorization); selection and control of UP function; configuring traffic steering at UPF to route traffic to proper destination; termination of interfaces toward policy control functions; controlling part of policy enforcement and QoS; lawful intercept (for SM events and interface to LI system); termination of SM parts of NAS messages; downlink data notification; initiating AN specific SM information, sent via AMF over N2 to AN; and determining SSC mode of a session. SM can refer to management of a PDU session, and a PDU session or “session” can refer to a PDU connectivity service that provides or enables the exchange of PDUs between a UE 302 and a DN 434 identified by a Data Network Name (DNN). PDU sessions can be established upon UE 302 request, modified upon UE 302 and 5GC CN 402 request, and released upon UE 302 and 5GC CN 402 request using NAS SM signaling exchanged over the NI reference point between the UE 302 and the SMF 424. Upon request from an application server, the 5GC CN 402 can trigger a specific application in the UE 302. In response to receipt of the trigger message, the UE 302 can pass the trigger message (or relevant parts/information of the trigger message) to one or more identified applications in the UE 302. The identified application(s) in the UE 302 can establish a PDU session to a specific DNN. The SMF 424 can check whether the UE 302 requests are compliant with user subscription information associated with the UE 302. In this regard, the SMF 424 can retrieve and/or request to receive update notifications on SMF 424 level subscription data from the UDM 414.

The SMF 424 can include the following roaming functionality: handling local enforcement to apply QoS SLAs (VPLMN); charging data collection and charging interface (VPLMN); lawful intercept (in VPLMN for SM events and interface to LI system); and support for interaction with external DN 434 for transport of signaling for PDU session authorization/authentication by external DN 434. An N16 reference point between two SMFs 424 can be included in the network architecture 400, which can be between another SMF 424 in a visited network and the SMF 424 in the home network in roaming scenarios. Additionally, the SMF 424 can exhibit the Nsmf service-based interface.

The NEF 408 can provide means for securely exposing the services and capabilities provided by 3GPP network functions for third party, internal exposure/re-exposure, Application Functions (e.g., AF 416), edge computing or fog computing systems, etc. In such embodiments, the NEF 408 can authenticate, authorize, and/or throttle the AFs 416. NEF 408 can also translate information exchanged with the AF 416 and information exchanged with internal network functions. For example, the NEF 408 can translate between an AF-Service-Identifier and an internal 5GC information. NEF 408 can also receive information from other network functions (NFs) based on exposed capabilities of other network functions. This information can be stored at the NEF 408 as structured data, or at a data storage NF using standardized interfaces. The stored information can then be re-exposed by the NEF 408 to other NFs and AFs, and/or used for other purposes such as analytics. Additionally, the NEF 408 can exhibit an Nnef service-based interface.

The NRF 410 can support service discovery functions, receive NF discovery requests from NF instances, and provide the information of the discovered NF instances to the NF instances. NRF 410 also maintains information of available NF instances and their supported services. As used herein, the terms “instantiate,” “instantiation,” and the like can refer to the creation of an instance, and an “instance” can refer to a concrete occurrence of an object, which can occur, for example, during execution of program code. Additionally, the NRF 410 can exhibit the Nnrf service-based interface.

The PCF 412 can provide policy rules to control plane function(s) to enforce them, and can also support unified policy framework to govern network behavior. The PCF 412 can also implement a front end (FE) to access subscription information relevant for policy decisions in a Uniform Data Repository (UDR) or user datagram protocol of the UDM 414. The PCF 412 can communicate with the AMF 422 via an N15 reference point between the PCF 412 and the AMF 422, which can include a PCF 412 in a visited network and the AMF 422 in case of roaming scenarios. The PCF 412 can communicate with the application function AF 416 via an N5 reference point between the PCF 412 and the AF 416; and with the SMF 424 via an N7 reference point between the PCF 412 and the SMF 424. The network architecture 400 and/or CN 402 can also include an N24 reference point between the PCF 412 (in the home network) and a PCF 412 in a visited network. Additionally, the PCF 412 can exhibit an Npcf service-based interface.

The UDM 414 can handle subscription-related information to support the network entities' handling of communication sessions, and can store subscription data of UE 302. For example, subscription data can be communicated between the UDM 414 and the AMF 422 via an N8 reference point between the UDM 414 and the AMF 422. The UDM 414 can include two parts, an application FE and a Uniform Data Repository (UDR) (the FE and UDR are not shown by FIG. 4). The UDR can store subscription data and policy data for the UDM 414 and the PCF 412, and/or structured data for exposure and application data (including PFDs for application detection, application request information for multiple UEs UE 302) for the NEF 408. The Nudr service-based interface can be exhibited by the UDR to allow the UDM 414, PCF 412, and NEF 408 to access a particular set of the stored data, as well as to read, update (e.g., add, modify), delete, and subscribe to notification of relevant data changes in the UDR. The UDM 414 can include a UDM-FE, which is in charge of processing credentials, location management, subscription management and so on. Several different front ends can serve the same user in different transactions. The UDM-FE accesses subscription information stored in the UDR and performs authentication credential processing, user identification handling, access authorization, registration/mobility management, and subscription management. The UDR can interact with the SMF 424 via an N10 reference point between the UDM 414 and the SMF 424. UDM 414 can also support SMS management, wherein an SMS-FE implements the similar application logic as discussed previously. Additionally, the UDM 414 can exhibit the Nudm service-based interface.

The AF 416 can provide application influence on traffic routing, provide access to the NCE, and interact with the policy framework for policy control. The NCE can be a mechanism that allows the 5GC CN 402 and AF 416 to provide information to each other via NEF 408, which can be used for edge computing implementations. In such implementations, the network operator and third party services can be hosted close to the UE 302 access point of attachment to achieve an efficient service delivery through the reduced end-to-end latency and load on the transport network. For edge computing implementations, the 5GC can select a UPF 432 close to the UE 302 and execute traffic steering from the UPF 432 to DN 434 via the N6 interface. This can be based on the UE subscription data, UE location, and information provided by the AF 416. In this way, the AF 416 can influence UPF (re)selection and traffic routing. Based on operator deployment, when AF 416 is considered to be a trusted entity, the network operator can permit AF 416 to interact directly with relevant NFs. Additionally, the AF 416 can exhibit a Naf service-based interface.

The NSSF 406 can select a set of network slice instances serving the UE 302. The NSSF 406 can also determine allowed NSSAI and the mapping to the subscribed single Network Slice Selection Assistance Information (S-NSSAIs), if needed. The NSSF 406 can also determine the AMF 422 set to be used to serve the UE 302, or a list of candidate AMF 422 based on a suitable configuration and possibly by querying the NRF 410. The selection of a set of network slice instances for the UE 302 can be triggered by the AMF 422 with which the UE 302 is registered by interacting with the NSSF 406, which can lead to a change of AMF 422. The NSSF 406 can interact with the AMF 422 via an N22 reference point between AMF 422 and NSSF 406; and can communicate with another NSSF 406 in a visited network via an N31 reference point (not shown by FIG. 4). Additionally, the NSSF 406 can exhibit an Nnssf service-based interface.

The CN 402 can include an SMSF, which can be responsible for SMS subscription checking and verification, and relaying SM messages to/from the UE 302 to/from other entities, such as an SMS-GMSC/IWMSC/SMS-router. The SMS can also interact with AMF 422 and UDM 414 for a notification procedure that the UE 302 is available for SMS transfer (e.g., set a UE not reachable flag, and notifying UDM 414 when UE 302 is available for SMS).

The CN 402 can also include other elements that are not shown by FIG. 4, such as a Data Storage system/architecture, a 5G-EIR, a SEPP, and the like. The Data Storage system can include a SDSF, an UDSF, and/or the like. Any NF can store and retrieve unstructured data into/from the UDSF (e.g., UE contexts), via N18 reference point between any NF and the UDSF (not shown by FIG. 4. Individual NFs can share a UDSF for storing their respective unstructured data or individual NFs can each have their own UDSF located at or near the individual NFs. Additionally, the UDSF can exhibit an Nudsf service-based interface (not shown by FIG. 4. The 5G-EIR can be an NF that checks the status of PEI for determining whether particular equipment/entities are blacklisted from the network; and the SEPP can be a non-transparent proxy that performs topology hiding, message filtering, and policing on inter-PLMN control plane interfaces.

Additionally, there can be many more reference points and/or service-based interfaces between the NF services in the NFs; however, these interfaces and reference points have been omitted from FIG. 4 for clarity. In one example, the CN 402 can include an Nx interface, which is an inter-CN interface between the Mobility Management Entity (MME) and the AMF 422 in order to enable interworking between CN 402 and other CN. Other example interfaces/reference points can include an N5g-Equipment Identity Register (EIR) service-based interface exhibited by a 5G-EIR, an N27 reference point between the Network Repository Function (NRF) in the visited network and the NRF in the home network; and an N31 reference point between the NSSF in the visited network and the NSSF in the home network. Further, any of the above functions, entities, etc. can include or be comprised by a component as referred to herein.

The LMF 426 (or individual instances of the LMF 426) is a core network component responsible for determining and managing the geographical location of user equipment (UE). The LMF collects data from the radio network and various other sources to calculate the position of the UE using techniques like triangulation, time of arrival (TOA), and observed time difference of arrival (OTDOA). It supports both network-based and UE-based positioning methods, with the network or the UE itself calculating the location based on available signals. The LMF interacts with the 5G base stations (gNodeB) to gather necessary measurements, and it can also leverage Global Navigation Satellite Systems (GNSS) for more accurate positioning when necessary. In addition to its role in determining device location, the LMF is responsible for sharing this information with authorized entities, such as location-based services or emergency responders. The LMF is vital for enabling services like emergency calls, where precise location information is required, and for supporting Internet of Things (IoT) applications where location tracking is necessary. It interfaces with other core network functions, like the Access and Mobility Management Function (AMF), and integrates seamlessly into the 5G service-based architecture to provide secure and reliable location services across various use cases. The LMF 426 may be deployed in a distributed manner. More than one LMF 426 can be present in the communication path between various NF Services. The LMF 426, although not an NF instance, can also be deployed distributed, redundant, and scalable.

The DN 434 may represent various network operator services, Internet access, or third party services that may be provided by one or more servers including, for example, application server 210. In some implementations, the DN 434 may be, or include, one or more edge compute nodes. Additionally, or alternatively, the DN 434 may be an Edge DN 434, which is a (local) Data Network that supports the architecture for enabling edge applications. In these embodiments, the application server 210 may represent the physical hardware systems/devices providing app server functionality and/or the application software resident in the cloud or at an edge compute node that performs server function(s). In some embodiments, the application server 210 provides an edge hosting environment that provides support required for Edge Application Server's execution.

The Access Stratum (AS) layer in a 3GPP system is responsible for the radio communication between the user equipment (UE) and the radio access network (RAN). It handles tasks related to the physical transmission of data over the air interface, including managing the establishment, maintenance, and release of radio connections. The AS layer oversees the radio resource control (RRC), which handles signaling between the UE and the base station (gNodeB in 5G or eNodeB in 4G), and it ensures that data is transmitted efficiently and reliably over the wireless link. This layer is involved in functions such as scheduling, handovers, and ensuring quality of service (QoS) for different types of data traffic.

In contrast, the Non-Access Stratum (NAS) layer operates between the UE and the core network, managing higher-level signaling that is not directly tied to the radio access network. The NAS layer is responsible for tasks such as mobility management, session management, and security between the UE and the core network (like AMF in 5G or MME in 4G). It handles authentication, network registration, location tracking, and the establishment of IP sessions, ensuring secure communication. While the AS layer manages the radio connection, the NAS layer oversees the broader network functions, allowing the device to communicate securely and move seamlessly across different network areas.

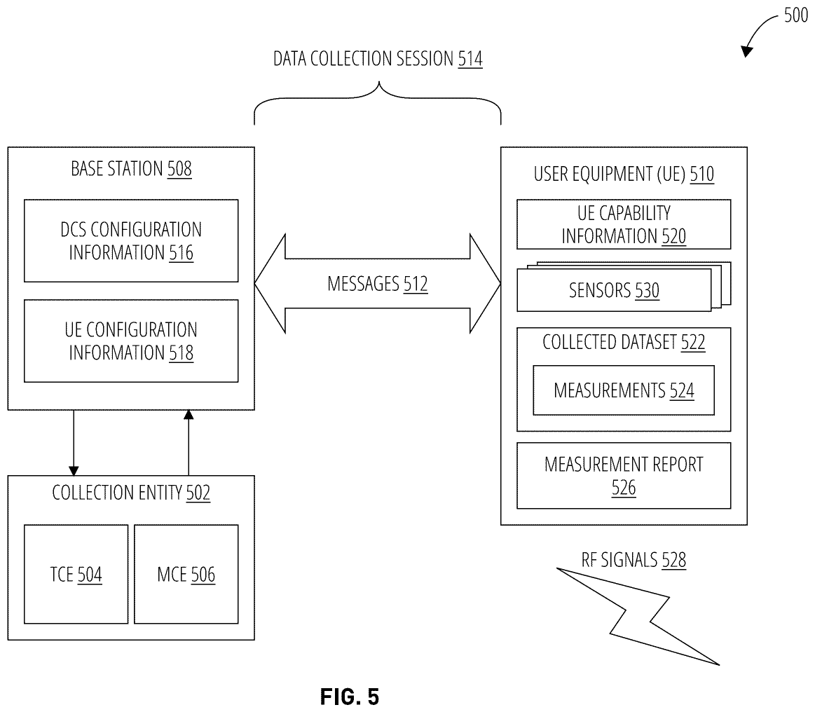

FIG. 5 illustrates a data collection system 500 to collect data suitable for the functional framework 100 and the wireless communication system 200, wireless communication system 300, and/or network architecture 400.

As depicted in FIG. 5, the data collection system 500 comprises a collection entity 502, a base station 508, and a UE 510. The collection entity 502, the base station 508, and the UE 510 may communicate various messages 512 associated with a data collection session 514. During the data collection session 514, a connection is formed between a base station 508 (e.g., a gNB 304) and a UE 510 for purposes of data collection. In this manner, the data collection system 500 causes the UE 510 to collect data during specified time periods, rather than on a continuous basis, thereby optimizing power savings for the UE 510.

The base station 508 encodes and sends messages 512 with DCS configuration information 516 and/or UE configuration information 518 to the UE 510, and it receives and decodes messages 512 with measurements 524 (e.g., in a measurement report) collected by the UE 510 from the UE 510. In some embodiments, the DCS configuration information 516 may comprise information for management of a given DCS. Non-limiting examples of DCS configuration information 516 for a DCS comprises configuration information associated with a particular data collection session 514, such as activation of a DCS, management of a DCS, deactivation of a DCS, length of a DCS, period of a DCS, purpose of the DCS, measurement objects for the DCS, reporting formats for the DCS, and so forth. In some embodiments, the DCS configuration information 516 may comprise information associated with a given ML model. Non-limiting examples of DCS configuration information 516 associated with a given ML model for a given DCS may include information such as a type of ML model, a type of data to be collected for an ML model, a condition for collecting data, a scenario for collecting data, a use case for collecting data, model parameters, types of training data, quantity of training data, DCS parameters, and other types of information related to an ML model or data collection for an ML model. Non-limiting examples of UE configuration information 518 comprises measurement objects, data collection session objects, UE assistance information (UAI), and so forth.

The UE 510 receives and decodes messages 512 with the DCS configuration information 516 from the base station 508, and it encodes and sends messages 512 with UE capability information 520 and collected data, such as measurements 524, to the base station 508. For example, the UE 510 receives and decodes the DCS configuration information 516 and/or UE configuration information 518 from the base station 508, and it starts collecting data based on the DCS configuration information 516 and/or UE configuration information 518. The UE 510 may include one or more sensors 530 to collect or measure RF signals 528 communicated to and from the UE 510 during the data collection session 514. The UE 510 stores the measurements 524 as part of a collected dataset 522. Once a sufficient number of measurements 524 are collected, based on the DCS configuration information 516 and/or UE configuration information 518, the UE 510 generates and encodes messages 512 such as a message with a measurement report that includes the collected dataset 522 with the measurements 524.

The base station 508 receives and decodes the messages 512 from the UE 510, and it either uses the measurements 524 for AI/ML tasks for an ML model 102 or trained ML model 120 implemented by the base station 508, or it forwards the measurements 524 to a collection entity 502 for use with an ML model 102 or a trained ML model 120 of the functional framework 100. The collection entity 502 is a network node or a processing thread on a network node with a globally unique identifier (ID) or address that is designed to receive and store the collected dataset 522 for the data collection session 514. The network node may comprise an OAM, a CN node (e.g., an AMF or LPF), a CN NF, or a base station 508. In some embodiments, the collection entity 502 is a trace collection entity (TCE), such as TCE 504. In some embodiments, the collection entity 502 is a measurement collection entity (MCE), such as MCE 506.

In various embodiments, the collection entity 502 may comprise or be implemented as a TCE 504. A TCE 504 in a 3GPP system is responsible for gathering trace data from various network components, including the radio access network, core network, and user equipment (UE). This trace data helps monitor network performance, troubleshoot issues, and ensure service quality. By collecting data related to signaling, session management, mobility events, and call flows, the TCE provides network operators with detailed insights into the network's behavior. This information is vital for identifying problems such as dropped calls, network congestion, or handover failures, and helps operators diagnose and resolve these issues efficiently. In addition to performance monitoring and troubleshooting, the TCE 504 plays a key role in compliance, auditing, and security. Trace data can be used for regulatory purposes, such as logging emergency calls, and for detecting security threats or fraudulent activities. The TCE 504 collects and analyzes comprehensive trace data across different network layers allowing operators to optimize network performance, maintain service reliability, and ensure that the network meets regulatory and quality standards.

In various embodiments, the collection entity 502 may comprise or be implemented as a measurement collection entity (MCE). An MCE in a 3GPP system is a network function responsible for gathering performance and quality measurements from various network elements, including the radio access network (RAN) and core network components. These measurements provide key performance indicators (KPIs) such as signal quality, throughput, latency, and handover success rates. By collecting this data, the MCE enables network operators to assess network health, optimize resource allocation, and improve overall network performance. In addition to performance monitoring, the MCE is used for network optimization and planning. The data it collects can be analyzed to identify coverage gaps, capacity issues, or underperforming network elements. This information helps operators make informed decisions about network expansion, upgrades, or reconfigurations to ensure efficient operation and high-quality user experiences. The MCE plays a role in enabling dynamic adjustments and proactive maintenance of the network, ensuring that the system remains responsive to changing demands.

While both the TCE 504 and MCE 506 are integral to the operation and maintenance of 3GPP-compliant networks, they focus on different aspects of network performance. The TCE 504 is geared toward detailed trace data for troubleshooting specific issues, while the MCE 506 handles regular performance measurements for continuous monitoring and optimization. Together, these entities provide network operators with comprehensive tools to maintain high performance, reliability, and swift resolution of potential issues.

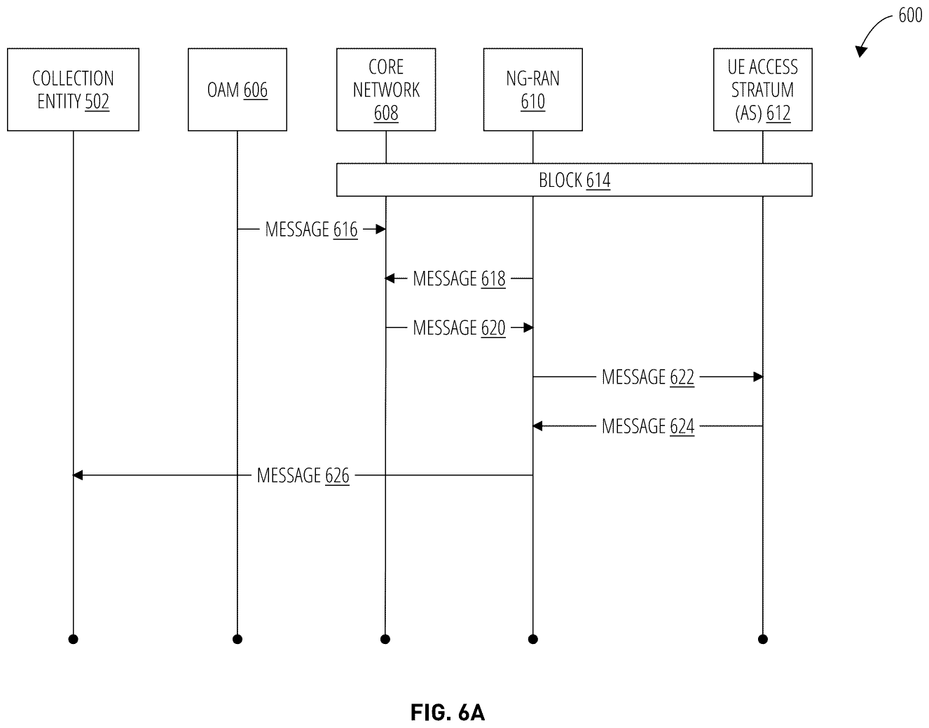

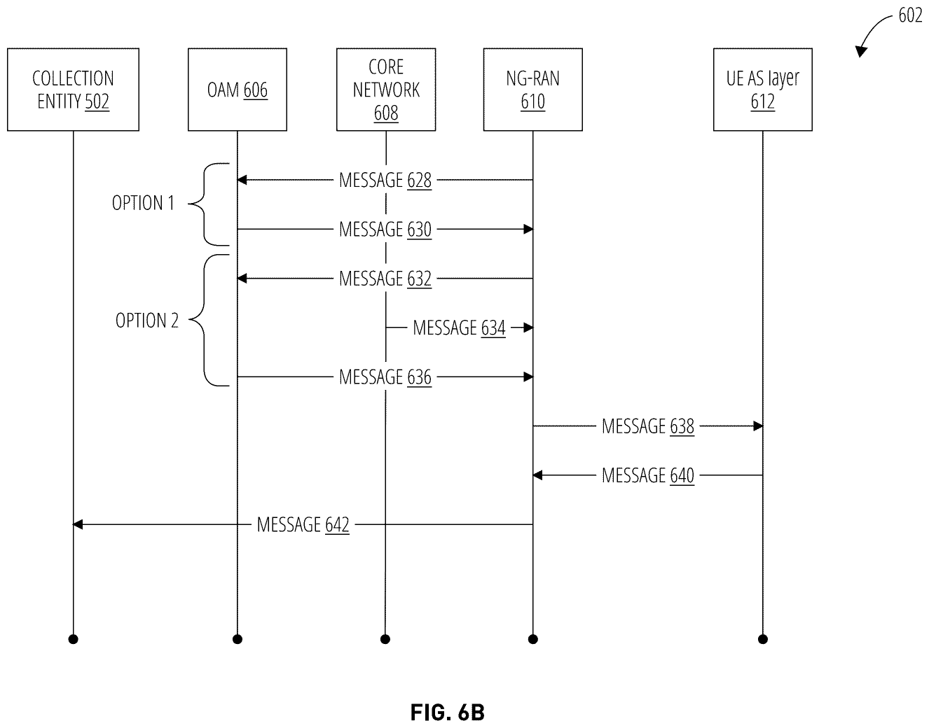

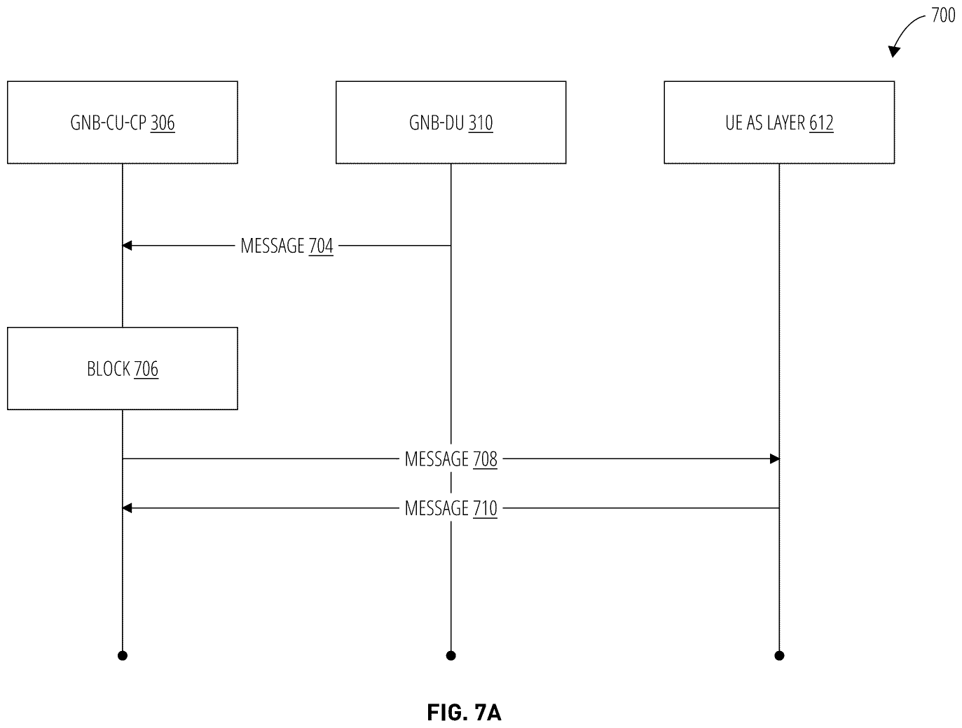

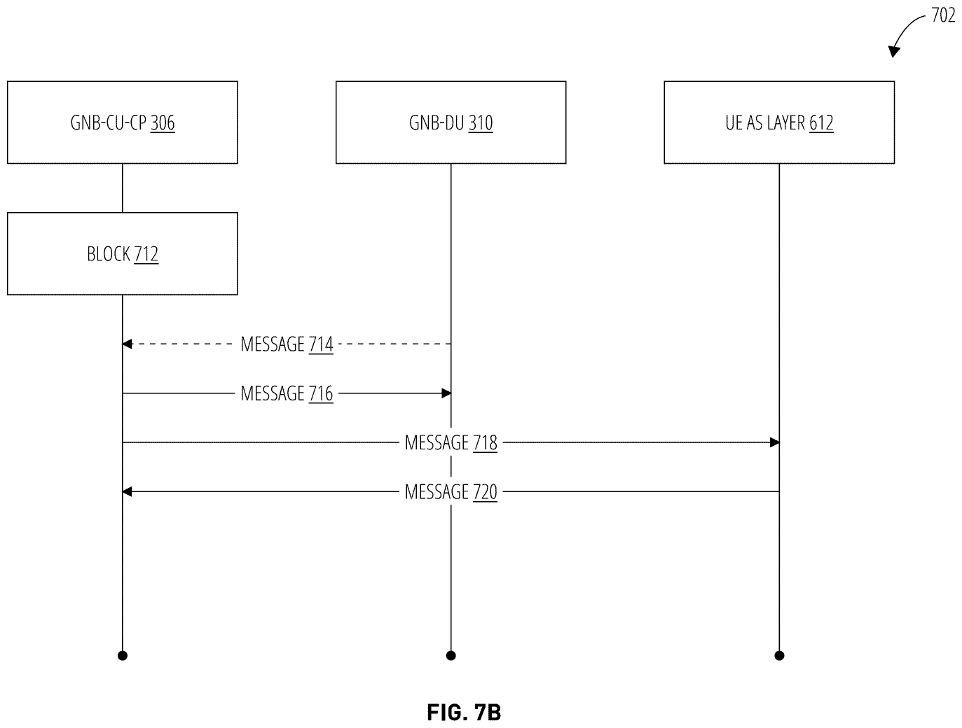

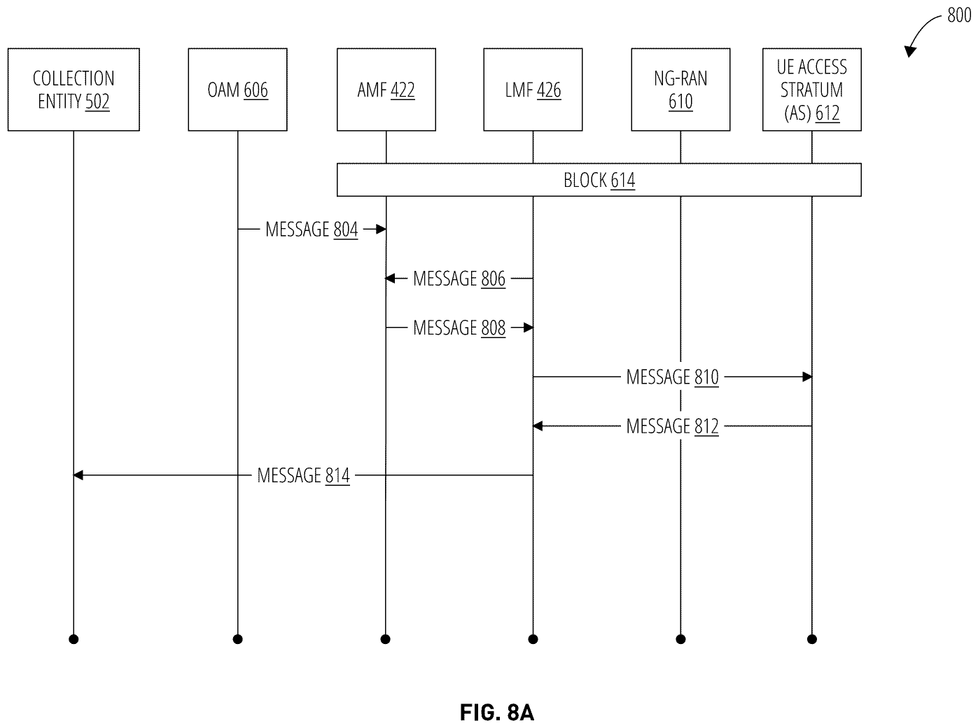

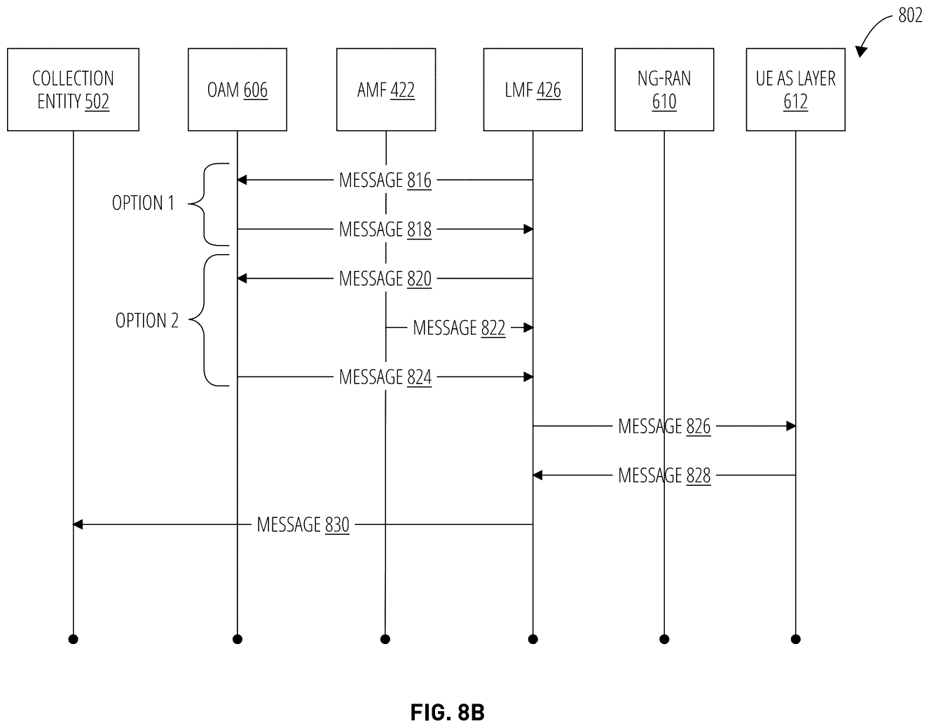

In various embodiments, the data collection system 500 may also comprise other network devices, such as an OAM network node and one or more network nodes implementing network functions (NFs) for a core network (CN), as described with reference to FIG. 6A, FIG. 6B, FIG. 7A, FIG. 7B, FIG. 8A, and FIG. 8B. In such cases, the messages associated with the data collection session 514 may traverse various network nodes in addition to the base station 508 and the UE 510 of the data collection system 500.

During the data collection session 514, a connection is formed between the base station 508 and UE 510 for purposes of data collection. The base station 508 and the UE 510 may exchange various types of information via the messages 512, such as configuration information defining a type of information to be collected by the UE 510, DCS configuration information 516 for an AI/ML model for which the data is to be collected, UE capability information 520, parameters associated with a data connection data collection session 514 (e.g., session activation, session deactivation, session period, etc.), context information for the UE 510 and/or base station 508 associated with a data collection session 514, such as UE capability information 520, gNB capability information, gNB workloads, number of UEs, handover operations, signal strength, MIMO settings, and other types of configuration information. The UE 510 then collects data for the data collection session 514, such as collecting measurements 524, and it sends the collected data to the base station 508. The base station 508 may use the collected data for AI/ML related tasks implemented by the base station 508. The base station 508 may also forward the collected data for AI/ML related tasks implemented by other network nodes in the wireless communication system 200, wireless communication system 300, and/or network architecture 400.

FIG. 6A illustrates a message flow 600 suitable for implementing embodiments as described herein. The message flow 600 illustrates an example of an exchange of messages 512 between a collection entity 502, an OAM 606, a CN 608, an NG-RAN 610 (e.g., base station 508 such as a gNB/gNB-CU/gNB-CU-CP), and a UE AS layer 612 of a UE 510, and various operations performed by one or more of the devices and/or NFs. The message flow 600 illustrates an example of an activation procedure to initiate an AI/ML trace function or measurement function for the collection entity 502 (e.g., a TCE 504 or MCE 506) for a data collection session 514. Specifically, the message flow 600 is an example of an activation procedure for a signaling-based data collection session 514.

In various embodiments, the message flow 600 is used to implement an MDT framework enhancement for AI/ML data collection. To support CSI, BM and positioning, when model training/model inference is located at a gNB 304, it is possible that the gNB 304 will initiate data collection to support model training/model inference at the gNB side. It is also possible that the OAM 606 is responsible for model training for a gNB 304, and it then deploys the ML model 102 to the gNB 304. In one embodiment, a new data collection session 514 is initiated by a gNB 304 (e.g., according to UE capability or NW decision), where the collected data is terminated at the gNB 304 and/or the OAM 606.

For a signaling-based data collection session 514, at block 614, the UE 510 accesses the 3GPP network using an attach procedure. For example, when the UE 510 attempts to access the 3GPP network, it begins by searching for available networks and establishing a connection with the radio access network (RAN), either through an eNodeB in 4G or a gNodeB in 5G. After synchronizing with the network, the UE sets up a Radio Resource Control (RRC) connection, which allows it to communicate with the network and exchange control information. Following this, the UE initiates Non-Access Stratum (NAS) signaling with the core network, sending a registration request to the Access and Mobility Management Function (AMF) in 5G or the Mobility Management Entity (MME) in 4G. This process is for establishing the identity and capabilities of the UE to the network. Once the registration is completed, the UE 510 undergoes authentication, where its identity is verified to ensure that it is authorized to access network services. After authentication, encryption is applied to secure communications. Finally, the UE 510 sets up a data session with the core network, receiving an IP address and the necessary resources to transmit and receive data. With this session established, the UE 510 can then access various network services such as voice, internet, or data communication. This entire process ensures that the UE 510 is securely and efficiently connected to the 3GPP network.

Once the UE 510 attaches to the 3GPP network at block 614, the OAM 606 sends a message 616 to the CN 608 (e.g., an AMF 422). The message 616 may comprise a session activation message to configure a data collection session 514 for activation by the NG-RAN 610. The message 616 may include DCS configuration information 516 such as a configuration for the ML model 102 for which data is to be collected, or UE configuration information 518 such as UAI. A base station 508 such as a gNB 304 of the NG-RAN 610 sends a message 618 to the CN 608 (e.g., the AMF 422) over an NG interface. The message 618 may comprise a session start request message to start the data collection session 514. The message 618 may include a data collection request for a specific UE, such as UE 510, and/or requested scenarios, among other types of information, such as UE context information, applicable conditions, scenarios, use cases, and other relevant information. In the context of 3GPP systems, UE context information refers to various data related to a UE and its usage patterns, such as location, network conditions, signal strength, battery level, and more. This information is used by the networks for optimizing service delivery, managing resources efficiently, and providing personalized experiences to users. Upon receiving the message 618, the CN 608 sends a message 620 to the NG-RAN 610. The message 620 may comprise a session start response message, including the AI/ML data collection configuration, for a specific UE 510. The session start response message may indicate a start of a trace session or a measurement session for the data collection session 514.

The NG-RAN 610 receives the message 620, and it sends a message 622 to the UE AS layer 612 of the UE 510. The message 622 may comprise a data collection request message. The data collection request message may include the DCS configuration information 516 or UE configuration information 518 (e.g., a trace configuration or a measurement configuration and UAI) for the data collection session 514. The UE AS layer 612 of the UE 510 receives the message 622, it collects measurements 524, and it sends a message 624 to the NG-RAN 610. The message 624 may comprise a data collection response message. The data collection response message may include a measurement report 526 comprising a collected dataset 522 that includes measurements 524 collected by the UE 510. In various embodiments, the message 622 and the message 624 are encoded as RRC messages. The NG-RAN 610 receives the message 624, and it forwards the measurements 524 to an address for the collection entity 502 via a message 626. The collection entity 502 may be executing on a network node of the 3GPP network, such as the OAM 606 or the CN 608.

FIG. 6B illustrates a message flow 602 suitable for implementing embodiments as described herein. The message flow 602 illustrates another example of an exchange of messages between a collection entity 502, an OAM 606, a CN 608, an NG-RAN 610 (e.g., base station 508 such as a gNB), and a UE AS layer 612 of a UE 510, and various operations performed by one or more of the devices and/or NFs. The message flow 602 illustrates an example of an activation procedure to initiate an AI/ML trace function or measurement function for the collection entity 502 (e.g., a TCE 504 or MCE 506) for a data collection session 514. Specifically, the message flow 602 is an example of an activation procedure for a management-based data collection session 514.

For management-based AI/ML data collection, the message flow 602 illustrates two options. In option 1, the NG-RAN 610 (e.g., a gNB/gNB-CU/gNB-CU-CP) sends a message 628 comprising a session start request message to the OAM 606. The message 628 may also include certain criteria, such as one or more application conditions, scenarios, use cases, and so forth. Upon receiving the session start request message, the OAM 606 sends a message 630 comprising a session start response message to the NG-RAN 610 indicating that a data collection session 514 is configured and ready for data collection. A base station 508 such as gNB 304 of the NG-RAN 610 can start a trace session or a measurement session in accordance with the AI/ML data collection configurations (e.g., DCS configuration information 516 and/or UE configuration information 518).

Similar to option 1, in option 2, the NG-RAN 610 (e.g., a gNB/gNB-CU/gNB-CU-CP) sends a message 632 comprising a session start request message to the OAM 606. The message 632 may include certain criteria, such as one or more application conditions, scenarios, use cases, and so forth. Upon receiving the session start request message, the OAM 606 sends a message 636 comprising a session start response message to the NG-RAN 610 indicating that a data collection session 514 is configured and ready for data collection. In this manner, a base station 508 such as gNB 304 of the NG-RAN 610 can start a data collection session 514 (e.g., a trace session or measurement session) in accordance with the AI/ML data collection configurations. Additionally, or alternatively, the CN 608 sends a message 634 to the NG-RAN 610, where the message 634 comprises an initial context setup request or a handover request, and it may include certain criteria, such as one or more application conditions, scenarios, use cases, and so forth.

The NG-RAN 610 receives the message 630, the message 634, and or the message 636, and it sends a message 638 to the UE AS layer 612 of the UE 510, such as a data collection request message that includes or forwards a measurement configuration and UE assistance information (UAI). The UE AS layer 612 of the UE 510 receives the message 638, and it sends a message 640 to the NG-RAN 610, such as a data collection response message comprising a measurement report including the collected dataset 522 comprising measurements 524 collected by the UE 510. In various embodiments, the message 638 and the message 640 are encoded as RRC messages. The NG-RAN 610 receives the message 640, and it forwards the measurements 524 to an address for the collection entity 502 via a message 642. The collection entity 502 may be executing on a network node of the 3GPP network, such as the OAM 606 or the CN 608.

In some embodiments, if data collection is terminated at a gNB (e.g., it is used for gNB model training), the message 626 in FIG. 6A and the message 642 in FIG. 6B are optional. If data collection is terminated at OAM 606 (e.g., used for OAM/CN model training), the message 626 in FIG. 6A and the message 642 in FIG. 6B are included.

In some embodiments, a base station 508 such as a gNB can include certain criteria for data collection, such as applicable conditions, scenarios, use case, and other information in the session activation message and/or session start request message. This may also include assistance information for UE 510 to perform data collection operations. The OAM 606 and/or CN 214 can activate/start a specific TCE session for the requested criteria.

In some embodiments, the OAM 606 and/or the CN 214 configure certain criteria when sending AI/ML configuration information. A base station 508 such as a gNB selects one or more suitable UEs 510 for AI/ML data collection based on criteria configured by the OAM 606 and/or the CN 608. The selection is based, at least in part, on the applicable conditions, scenarios, or use cases for AI/ML data collection that are received from the management system (e.g., OAM 606) and the corresponding information that UE 510 reported (e.g. UAI, as part of model metadata information, UE capability information 520, etc.). If the UE 510 does not fit applicable conditions, scenarios, and/or use cases for a given data collection, or it does not appear in a CN 608 configured initial context setup request and/or handover request, the gNB does not select the UE 510 for AI/ML data collection. The gNB can also take UE capability information 520 into account. If the UE 510 is not capable of specific use case or general AI/ML functionality, the gNB can consider not to select it for AI/ML data collection. Note that the ability or suitability of a UE 510 to participate in AI/ML data collection may be different from the capability and applicable conditions for a UE 510 to use an AI/ML model.

It is worthy to note that a measurement report can also include the applicable conditions, scenarios, or use cases for each set of collected data or collection dataset. Further, the applicable conditions, scenarios, and use cases can be represented by appropriate identifiers. In addition, different data collection purposes (e.g. for model training, for model inference, for model monitoring) can create different TCE and MCE sessions, correspondingly.

For deactivation, where an AI/ML trace function or measurement function or data collection session 514 is initiated by NG-RAN 610, the NG-RAN 610 can send a deactivation trace request message to CN 608 (e.g., over a NG interface) or to OAM 606. The CN 608 and/or OAM 606 then deactivates the gNB trace session via a DEACTIVATE TRACE message or service based management architecture (SBMA).

Some embodiments further include a logged AI//ML enhancement. For logged AI/ML data collection, a configuration parameter to collect AI/ML related information (including training, inference, monitoring) may be carried over an RRC message from the NG-RAN 610 to the UE 510, via an existing LoggedMeasurementConfiguration message or a new message for AI/ML logged data collection. Existing configuration parameters captured in 3GPP TS 37.321, for example, can be reused by AI/ML logged data collection with certain configuration enhancements.

To log an AI/ML collection dataset for model training, configuration of trigger of logging event can also provide a configuration of applicable scenario, condition, and/or use case for logging AI/ML related data to the UE 510 (e.g., measurements 524), such that when UE 510 enters such configured applicable scenarios or conditions, the UE 510 starts logging requested data. Alternatively, the UE 510 can also implicitly know when to trigger measurement based on a TCE identifier (ID) if different TCE sessions are created for different applicable conditions, scenarios, and/or use cases. Alternatively, applicable scenarios, conditions, and/or use cases can also be provided as assistance information to UE 510 (e.g., UAI). An identifier can be used to link between assistance information and requested data for collection. Or all data is requested to collect under the assistance information provided by the network.

In some embodiments, logged AIML data collection can also be used to log data when UE 510 is in an RRC_CONNECTED state for AI/ML data collection. Configuration of an RRC state for data collection can also be configured by the NG-RAN 610 for an RRC_IDLE/INACTIVE state and/or an RRC_CONNECTED state.

In some embodiments, the logging duration can also include multiple duration configurations, such as a start timestamp plus a stop timestamp or a start timestamp plus a duration value. The logging duration can also include a time granularity within the duration, indicating the expiry of one or more sets of configurations.

In some embodiments, if a TCE session or a new data collection session 514 for AI/ML data collection is used for AI/ML data collection, one or more new logged AI/ML types can be introduced for AI/ML dataset collection. Examples of AI/ML types may include an indication of logged measurement configuration is for gNB-initiated AI/ML data collection, indication of logged measurement configuration is for model training data collection, indication of logged measurement configuration is for model inference data collection, indication of logged measurement configuration is for model monitoring data collection, and so forth.

In some embodiments, the UE 510 can also indicate a capability about whether it supports logged AI/ML data collection measurement during an RRC_CONNECTED state. For example, the UE 510 may send the UE capability information 520 to the base station 508 to indicate whether it supports logged AI/ML data collection measurements.

In some embodiments, the UE capability information 520 for the UE 510 may also indicate a capability about whether it supports collecting data. This UE capability information 520 may be the same or different from UE capability information 520 to support AI/ML data collection operations.

In some embodiments, the configuration parameter, including but not limit to configuration parameters in LoggedMeasurementConfiguration and above enhancements, may be configured per applicable scenario, condition, use case or request data/dataset, if a same TCE ID or session ID is used among some/all applicable conditions or use cases.

In some embodiments, when UE 510 is in an RRC_CONNECTED state, the configuration can be made effective, and the UE 510 performs logging per logged measurement configuration if it is configured to collect AI/ML data/dataset in RRC_CONNECTED state. When UE 510 is in RRC_IDLE/INACTIVE state, the configuration with corresponding RRC state becomes active and UE 510 starts to perform logging per request.

In some embodiments, considering a limited memory size at UE 510, a collection priority may be used when logging data collection. When a buffer becomes full, the UE 510 may not go to an RRC_CONNECTED state just for data collection reporting. The network can configure different priority per TCE ID or per logged MDT type or per applicable scenario/use case. The logged data with higher priority can replace/overwrite the existing logged data with lower priority. Potential priority between different logged MDT types can be model monitoring>model training>others. Other priority orders are not precluded.

In some embodiments, during measurement collection, a UE corresponding scenario (e.g., environment, speed, if trigger event is periodicity time interval, etc.) and the collection time stamp (if trigger event is based on applicable conditions) can also be logged for each required data. The information should be reported to the network together when measurement reporting is triggered.

In some embodiments, if RRC_CONNECTED state is configured to collect data, certain reporting events can be considered, similar to RRM measurement and enhancement as discussed herein.

In some embodiments, for measurement reporting, UL RRC segmentation is supported for AI/ML data collection reporting. In some cases, a segment number larger than 16 may also be implemented.

Some embodiments may implement an availability indicator. The availability indicator is a new type of indicator to indicate the availability of logged AI/ML data collection can be included in RRCSetupComplete message or RRCResumeComplete message during connection establishment. Furthermore, the availability indicator can be included in some additional uplink RRC messages, e.g., RRCReconfigurationComplete message, RRCReestablishmentComplete message, or UEInformationResponse message, at every transition to RRC Connected mode even though the logging period has not ended. The availability indicator can be 1 bit to indicate overall availability of AI/ML data collection, or one indicator per applicable scenario/use case/data type, either encoding within UE-MeasurementAvailable information element (IE) or a new IE (e.g. UE-AIML-DataAvailable).

In some embodiments, a reporting parameter includes collected data/dataset, timestamp and/or duration of each collected data (within dataset), collected conditions (applicable conditions, including scenario, UE speed, etc). The reported data can either be in container or defined with specific IEs.

In some embodiments, RRM measurement is enhanced to include information for collection, trigger events, reporting information, and other data collection session parameters. This is described in more detail below with reference to gNB-setup AI/ML data collection session.

In some embodiments, an AI/ML data collection session can be a new session specified for AI/ML data collection terminated at OAM 606 or embedded in existing MDT framework (e.g. TCE session) with the above described enhancements.

In some embodiments, the applicable conditions, configurations, scenarios, and/or use cases of data reported from UE 510 can also associate to a UE configuration setting (e.g. via UAI or UE capability or other RRC messages for reporting UE applicable conditions, etc) via an identifier.

In some embodiments, an AI/ML data collection session 514 may terminate at an OAM 606 and/or a CN 608 as described with reference to FIG. 6A and FIG. 6B. Additionally, or alternatively, a base station 508 such as a gNB may also be a termination point of an AI/ML data collection session 514.

For example, in a non-CU-DU split architecture, model inference, model training and model management may be located at a gNB. In a CU-DU split architecture, different functionality mappings may be defined. A first functionality mapping may comprise a gNB-DU performing model inference and a gNB-CU performing model training, model monitoring, and model management. A second functionality mapping may comprise a gNB-DU performing model inference and model management and a gNB-CU performing model training. A third functionality mapping may comprise a gNB-DU performing model inference, model management, and model training. A fourth functionality mapping may comprise a gNB-CU performing model inference, model management, and model training. Embodiments are not limited to these examples.

In a CP-UP split architecture, different functionality mappings may be defined. A first functionality mapping may comprise a gNB-DU performing model inference and a gNB-CU-CP performing model training and model monitoring/management. A second functionality mapping may comprise a gNB-DU performing model inference and model management and a gNB-CU-CP performing model training. A third functionality mapping may comprise a gNB-DU performing model inference, model management, and model training. A fourth functionality mapping may comprise a gNB-CU-CP performing model inference, model management, and model training. Embodiments are not limited to these examples.

FIG. 7A illustrates a message flow 700 suitable for implementing embodiments as described herein. The message flow 700 illustrates an example of an exchange of messages between a gNB-CU-CP 306, a gNB-DU 310, and a UE AS layer 612 for a UE 510, and various operations performed by one or more of the devices and/or NFs. The message flow 700 illustrates an example of an activation procedure to initiate an AI/ML trace function or measurement function for the collection entity 502 (e.g., a TCE or MCE) for a data collection session 514. Specifically, the message flow 700 is an example of an activation procedure (e.g., session start, session setup, session initiation) for a data collection session 514 initiated by a gNB-DU 310 and when a termination of the data collection session 514 is at a gNB 304, gNB-CU 314, and/or gNB-CU-CP 306.

As depicted in FIG. 7A, the gNB-DU 310 sends a message 704 comprising a session start request message which is a session setup request to initiate data collection activation to a gNB-CU-CP 306 (or a gNB-CU 314), over an F1 interface, for example. The message 704 may include certain criteria, such as a requested UE context, configuration information, and/or applicable scenario. Alternatively, at block 706, the gNB-CU-CP 306 can also setup the AI/ML data collection session 514 on its own without a trigger from a gNB-CU-UP 308 or gNB-DU 310. Alternatively, gNB-CU 314 and/or gNB-CU-CP 306 can initiate session setup on its own. The gNB-CU-CP 306 sends a message 708 with DCS configuration information 516 (e.g., a measurement configuration) to the UE AS layer 612 of the UE 510 for data collection via the gNB-DU 310. The message 708 may comprise a data collection request message. The gNB-CU-CP 306 may send the message 708 based on its own selection based on UE capability information 520, configured use cases, or other parameters, or the received request from gNB-DU 310 (if any), including applicable scenario, RRC state, configuration, use case, and other types of information. The UE AS layer 612 sends a message 710 to the gNB-CU-CP 306 with the collected data, such as a measurement report comprising collected dataset 522 with measurements 524. The message 710 may comprise a data collection response message. The gNB 304, gNB-CU 314, gNB-CU-CP 306 may further communicate AI/ML data collection configurations to the UE AS layer 612 of the UE 510 using RRC messages, for example.

FIG. 7B illustrates a message flow 702 suitable for implementing embodiments as described herein. The message flow 702 illustrates an example of an exchange of messages between a gNB-CU-CP 306, a gNB-DU 310, and a UE AS layer 612 for a UE 510, and various operations performed by one or more of the devices and/or NFs. The message flow 702 illustrates an example of an activation procedure to initiate an AI/ML trace function or measurement function for the collection entity 502 (e.g., a TCE or MCE) for a data collection session 514. Specifically, the message flow 702 is an example of an activation procedure (e.g., session start, session setup, session initiation) for a data collection session 514 initiated by a gNB-CU 314 or gNB-CU-CP 306 and when a termination of the data collection session 514 is at a gNB 304, gNB-CU 314, and/or gNB-CU-CP 306.

As depicted in FIG. 7B, at block 712, the gNB-CU-CP 306 initiates a data collection session 514. The gNB-DU 310 may optionally send a message 714 comprising a session start request message for a specific UE data collection. The gNB-CU-CP 306 may send a message 716 to the gNB-DU 310. The message 716 may comprise a session start response message to the session start request message received from the gNB-DU 310. Alternatively, the message 716 may be a session activation message indicating a data collection session 514 has been configured and activated by the gNB-CU-CP 306. The message 716 may include certain defined criteria for the data collection session 514, as identified by a session identifier, such as applicable conditions, scenarios, use cases, UE context, and so forth. The gNB-CU-CP 306 may send a message 718 to the UE AS layer 612 of the UE 510 via the gNB-DU 310. The message 718 may comprise a data collection request message including a forward measurement configuration. The UE 510 receives the message 718, and it initiates data collection operations by taking various measurements 524. The UE AS layer 612 then sends a message 720 comprising a data collection response message comprising a measurement report 526 with the collected dataset 522 comprising the measurements 524 to the gNB-CU-CP 306. Note the message 718 and the message 720 may be implemented as existing or new 3GPP RRC messages. The session and configuration for AI/ML data collection can also be considered for enhancements to configuration/reporting as described with reference to FIG. 6A and FIG. 6B.

The gNB-CU-CP 306 uses the measurements 524 for model training, model inference, model management, and other AI/ML related operations. When model training and/or model inference and/or model monitoring is located at gNB-DU 310, the collected data from UE 510 carried over RRC messages is sent from gNB-CU 314 or gNB-CU-CP 306 to gNB-DU 310, e.g. over new or existing messages in F1 interface. The collected data can be sent either periodically or as a one-time shot based on the data, data type, applicable condition, scenarios, use case, UE 510, and other factors. The gNB 304, gNB-CU 314, and/or gNB-CU-CP 306 can also configure measurement configurations according to UE settings (e.g., UAI, as part of model metadata information, UE capability, etc.).

Various embodiments may enhance radio resource management (RRM) measurements using configuration information, such as DCS configuration information 516. The network may configure the UE 510 to perform data collection such as taking measurements 524 for various AI/ML related tasks, such as model training, performance monitoring, model inference, model management, and so forth. The network may also configure the UE 510 to report various types of information, such as a target CSI (e.g. precoding matrix or channel matrix, precoding matrix for Type 3 separate training in two-sided model when the UE 510 trains first), L1-RSRP, beam ID, timing, power and/or phase information, reconstructed CSI, calculated performance matrix, ground truth CSI feedback, and so forth. The network can configure the UE 510 with various parameters for AI/ML data collection, such as: (1) data type and information; (2) data type, indicating all information for the specific purpose should be collected/reported, what information is needed for specific data type can be inferred from model metadata information, AI/ML use case, and so forth; and/or (3) certain types of information.

In some embodiments, the DCS configuration information 516 may include measurement configuration information for reporting collected data. For example, the measurement configuration for AI/ML data collection can reuse a measConfig IE or configure a new IE for AI/ML data collection within an RRCReconfiguration message or a new message, possibly using a separate system restoration block (SRB) (e.g., a new SRB). The measurement configuration (including measurement object, report configuration, quantity, etc) for AI/ML data collection can be added, modified, or removed. The measurement/collection of AI/ML data collection can also be independent from carrier frequency.

In some embodiments, the data collection assistance information, applicable conditions, scenarios, or use cases can be configured as measurement objects, or a new object (e.g. AI/ML data collection object) for the purpose of data collection. The measurement object or new object can be configured as measurement and/or AI/ML data collection objects, e.g., for model training, performance monitoring, model management, and so forth. Alternatively, the information can be provided by the network as assistance information to the UE 510, where an identifier is linked between the two, or when all data collection should follow assistance information.

In some embodiments, the network can also provide configuration for the duration of AIML data collection (e.g., start time+duration or start time+stop time, periodicity, etc.) via ReportConfigNR or a new configuration for AI/ML data collection reporting. This is used to indicate a period when the UE 510 performs AI/ML data collection (e.g. for model training) for the configured data collections. The duration of a data collection session 514 can also be configured as part of a measurement object or an AI/ML data collection object, such as a new measurement timing configuration (MTC) list. If a dataset is required, the network can also indicate the required duration of one dataset independently, as a subset of duration in the MTC. The measurement timing configuration for AI/ML data collection can be use case specific and/or applicable scenario or condition specific and/or information specific.

In some embodiments, the network can also use buffer threshold at the UE side (e.g. per UE or per collected information) as part of the reporting criterion. The UE 510 reports the data/dataset (e.g., for model training or model monitoring) to the network when entering the condition, such as when the stored data reaches the configured buffer threshold.

In some embodiments, the network can also use a defined timer threshold to trigger reporting of an AI/ML data/dataset. The UE 510 reports buffered/stored data/datasets when entering the condition or when the timer expires.

In some embodiments, the network can also use a scenario or condition change to trigger reporting of an AI/ML data/dataset. The UE 302 reports buffered/stored data/datasets when the environment at the UE 510 is changed, such as from UMi to UMa, a UE speed change higher than a certain threshold, beam set change, location, and other environmental conditions.

In some embodiments, the network can also data/model quality/accuracy as a threshold to trigger reporting of AI/ML data/dataset. The UE 510 reports buffered/stored data/datasets when the data/model quality/accuracy level is lower than a certain threshold. Alternatively, this data/model accuracy/quality can also be configured as part of measurement object, where UE 510 is only allowed to report data above the configured accuracy/quality to the network. It is worthy to note that existing reporting triggers can also be used to report an AI/ML data collection.

For measurement reporting, for each requested data/dataset/data within a dataset, the UE 510 reports its corresponding timestamp, data accuracy/quality, applicable condition/scenario (or collected condition/scenario), UE speed, and so forth. An UL RRC segmentation can be supported for measurement reporting if the packet data unit (PDU) size is above a threshold, such as larger than 8000 bytes, for example. The maximum number of UL RRC segments can also be increased according to a UE AS layer 612 buffer size or buffer revered for an AI/ML data collection.

In some embodiments, the UE 510 can also be configured with a priority level when reporting multiple data collection to the network, such as a higher priority for performance monitoring data/dataset, for example. The UE 510 can report the data collection with higher priority first if a maximum RRC message size (with segments) is reached. Multiple RRC messages can be generated, if needed.

FIG. 8A illustrates a message flow 800 suitable for implementing embodiments as described herein. The message flow 800 illustrates an example of an exchange of messages between a collection entity 502, an OAM 606, various network nodes or NFs for the CN 608 such as the AMF 422 and LMF 426, an NG-RAN 610 (e.g., base station 508 such as a gNB/gNB-CU/gNB-CU-CP), and a UE AS layer 612 of a UE 510, and various operations performed by one or more of the devices and/or NFs. The message flow 800 illustrates an example of an activation procedure to initiate an AI/ML trace function or measurement function for the collection entity 502 (e.g., a TCE or MCE) for a data collection session 514. Specifically, the message flow 800 is an example of an activation procedure for a management-based data collection session 514.

In various embodiments, the message flow 800 is used to implement an LTE positioning protocol (LPP) and/or secure LPP (SLPP) enhancement for AI/ML data collection. LPP is a positioning protocol for LTE that is focused on determining the location of the UE. SLPP is a secure version of LPP, with added security features like encryption and authentication to protect location data. Similar to FIG. 6A and FIG. 6B, the enhancements for measurement configuration and/or reporting can also be applicable to LPP or SLPP data collection for positioning accuracy enhancement use cases.

To support LPP and SLPP, it is possible that the CN 608 will initiate data collection to support model training/model inference at the network side or gNB side. It is also possible that the OAM 606 is responsible for model training for an ML model 102, and it then deploys the trained ML model 120 to a network node in the CN 608 or the base station 508 (e.g., a gNB). In one embodiment, a new data collection session 514 is initiated by a NF of the CN 608 (e.g., according to UE capability or NW decision), such as the LMF 426, where the collected data is terminated at the gNB, the OAM 606, or the CN 608.

For a signaling-based data collection session 514, at block 614, the UE 510 accesses the 3GPP network using an attach procedure as described with reference to FIG. 6A. Once the UE 510 attaches to the 3GPP network at block 614, the OAM 606 sends a message 804 to the AMF 422 of the CN 608. The message 804 may comprise a session activation message to configure a data collection session 514 for activation. The message 804 includes DCS configuration information 516 such as a configuration for the ML model 102 for which data is to be collected. The LMF 426 of the CN 608 sends a message 806 to the AMF 422 of the CN 608. The message 806 may comprise a session start request message over the message bus 436. The message 806 may include a data collection request for a specific UE, such as UE 510, and/or requested scenarios, among other types of information. Upon receiving the message 806, the AMF 422 of the CN 608 sends a message 808 to the LMF 426. The message 808 may comprise a session start response message, such as a trace start message, including the AI/ML data collection configuration, for a specific UE 510.

The LMF 426 receives the message 808, and it sends a message 810 to the UE AS layer 612 of the UE 510 via NG-RAN 610. The message 808 may comprise a data collection request message to forward a measurement configuration and UE assistance information (UAI). The UE AS layer 612 of the UE 510 receives the message 810, and it sends a message 812 to the LMF 426 via the NG-RAN 610. The message 812 may comprise a data collection response message comprising a measurement report 526 including a collected dataset 522 with measurements 524 collected by the UE 510. The LMF 426 receives the message 812 via the NG-RAN 610, and it forwards the measurements 524 to an address for the collection entity 502 via a message 814. The collection entity 502 may be executing on a network node of the 3GPP network, such as the OAM 606 or a NF of the CN 608.

As depicted in FIG. 8A, the LMF 426 triggers the activation procedure instead of a gNB 304. Further, the LMF 426 configures the AI/ML data collection (similar to MDT framework) via LPP and/or SLPP protocol. The AI/ML data collection configuration may be configured by LMF 426 via LPP and/or SLPP, and the UE 510 should report it back to the LMF 426 via LPP and/or SLPP. LPP and SLPP also support message segmentation, and the RRC limitation is still valid for them. There is no measurement object concept in LPP and SLPP. Embodiments introduce a similar concept as a new measurement object or AI/ML data collection object is provided by LMF 426 to configure the UE 510 for data collection reporting. The capability may be reported by UE 510 in accordance with one or more procedures defined by one or more 3GPP standards, such as: (1) Provide Capabilities, where the configuration may be provided by the LMF 426 via Provide Assistance Data; (2) Request Location Information, where the measurement results could be provided by UE 510 via Provide Location Information. Embodiments are not limited to these examples.

FIG. 8B illustrates a message flow 802 suitable for implementing embodiments as described herein. The message flow 802 illustrates another example of an exchange of messages between a collection entity 502, an OAM 606, an AMF 422 of the CN 608, an LMF 426 of the CN 608, an NG-RAN 610 (e.g., base station 508 such as a gNB), and a UE AS layer 612 of a UE 510, and various operations performed by one or more of the devices and/or NFs. The message flow 802 illustrates an example of an activation procedure to initiate an AI/ML trace function or measurement function for the collection entity 502 (e.g., a TCE or MCE) for a data collection session 514. Specifically, the message flow 802 is an example of an activation procedure for a management-based data collection session 514.

Similar to message flow 800, the message flow 802 is used to implement a LPP and/or SLPP enhancement for AI/ML data collection. For management-based AI/ML data collection, the message flow 802 illustrates two options. In option 1, the LMF 426 sends a message 816 comprising a session start request message to the OAM 606. The message 816 may include certain criteria, such as one or more application conditions, scenarios, use cases, and so forth. Upon receiving the request, the OAM 606 sends a message 818 comprising a session start response message to the LMF 426, where the LMF 426 can start a trace session in accordance with the AI/ML data collection configurations.

Similar to option 1, in option 2, the LMF 426 sends a message 820 comprising a session start request message to the OAM 606. The message 632 may include certain criteria, such as one or more application conditions, scenarios, use cases, and so forth. Upon receiving the request, the OAM 606 sends a message 824 comprising a session start response message to the LMF 426, where the LMF 426 can start a trace session in accordance with the AI/ML data collection configurations. In addition, the AMF 422 sends a message 822 to the LMF 426, where the message 822 comprises an initial context setup request or a handover request, and it may include certain criteria, such as one or more application conditions, scenarios, use cases, and so forth.

The LMF 426 receives the message 818, the message 822, and or the message 824, and it sends a message 826 to the UE AS layer 612 of the UE 510 via the NG-RAN 610, such as a data collection request message that forwards a measurement configuration and UE assistance information (UAI). The UE AS layer 612 of the UE 510 receives the message 826, and it sends a message 828 to the LMF 426 via the NG-RAN 610, such as a data collection response message comprising a measurement report 526 comprising a collected dataset 522 including measurements 524 collected by the UE 510. The LMF 426 receives the message 828, and it forwards the measurements 524 to an address for the collection entity 502 via a message 830. The collection entity 502 may be executing on a network node of the 3GPP network, such as the OAM 606 or the CN 608.

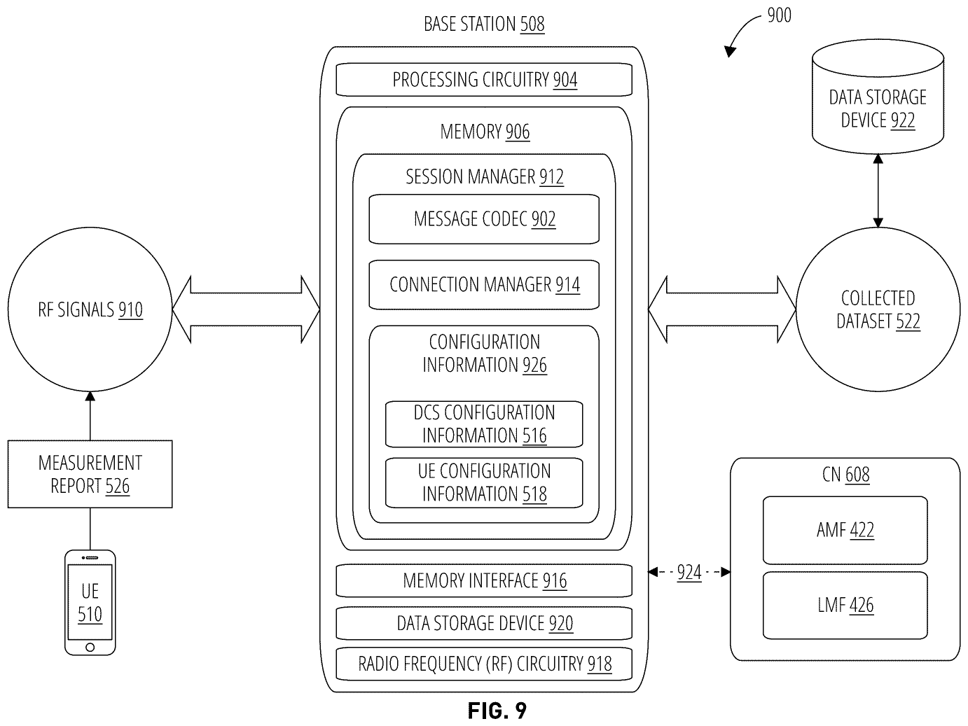

FIG. 9 illustrates a 3GPP system 900 having a base station 508 in communication with a UE 510 and a CN 608. The 3GPP system 900 may be representative of any wireless system, such as a wireless communication system 200 or the wireless communication system 300.

As depicted in FIG. 9, a 3GPP system 900 comprises apparatus such as base station 508, a UE 510, a CN 608, and a data storage device 922. The base station 508 includes processing circuitry 904 operably coupled to a memory 906. The memory 906 may store program instructions for a session manager 912. The session manager 912 may manage a data collection session 514. The session manager 912 may further include a message codec 902 to encode and decode messages, and a connection manager 914 to manage connections with one or more UEs 510. The memory 906 may also store configuration information 926 such as DCS configuration information 516 and UE configuration information 518.

The base station 508 includes a memory interface 916 for memory 906 to send or receive, to or from a data storage device 920 and/or data storage device 922, data collection information for a 5G or 6G wireless system. The data collection information includes a collected dataset 522 for an ML model 102 or trained ML model 120 of the functional framework 100. The base station 508 includes processing circuitry 904 communicatively coupled to the memory interface of the memory 906, the processing circuitry 904 to execute instructions for a message codec 902 to encode a session start request message to start a data collection session 514 to collect data for the ML model 102 or trained ML model 120 from a UE 510. The session start request message may include UE context information. The message codec 902 may decode a session start response message to indicate the start of the data collection session 514 by the base station 508. The session start response message may include configuration information 926, such as DCS configuration information 516 for the ML model 102 or trained ML model 120 and UE configuration information 518 for the UE 510. The message codec 902 may encode a data collection request message for the UE 510 to collect measurements 524 based on the DCS configuration information 516 for the ML model 102 or trained ML model 120 for the base station 508. The data collection request message may include measurement configuration information and UE assistance information (UAI).

The message codec 902 of the base station 508 may decode a data collection response message from the UE 302, the data collection response message including a measurement report 526 with the collected measurements 524 for the ML model 102 or trained ML model 120.

The message codec 902 may also encode a data collection response message from the UE 510 for a NF of a CN 608 of the 5G or 6G wireless system, such as AMF 422 or LMF 426, or an OAM 606 of the 5G or 6G wireless system. The data collection response message may comprise the measurement report 526 with the collected measurements 524 for the ML model 102 or trained ML model 120.

The message codec 902 may also encode the session start request message for a NF of the CN 608 of the 5G or 6G wireless system, such as AMF 422 or LMF 426, and decode the session start response message from the NF of the CN.

The message codec 902 may further encode the session start request message for an OAM 606 of the 5G or 6G wireless system, and decode the session start response message from the OAM 606.

The base station 508 may be implemented as a gNB 304 divided into a gNB-CU-CP 306 and a gNB-DU 310. In this case, the message codec 902 further encodes the session start request message for the gNB-CU-CP 306 of the gNB 304 by the gNB-DU 310.

The message codec 902 may further decode an initial context setup request message or a handover request message from a NF of the CN 608 of the 5G or 6G wireless system.

The data collection session 514 is managed by a collection entity 502 of the 5G or 6G wireless system. The collection entity 502 may comprise a TCE 504 or an MCE 506.

The data collection session 514 is managed by a collection entity 502 of the 5G or 6G wireless system, where the collection entity 502 is implemented as part of a NF of the CN 608 of the 5G or 6G wireless system, such as AMF 422 or LMF 426, an OAM 606 of the 5G or 6G wireless system, or the base station 508.

When the ML model 102 or trained ML model 120 is implemented by the base station 508, the base station 508 may train the ML model 102 or the trained ML model 120 using the measurements 524, or generate predictions using the ML model 102 or trained ML model 120 based on the measurements 524.

The base station 508 may also include RF circuitry 918 to send the encoded messages and receive the decoded messages as RF signals 910.

Similar to the base station 508, an apparatus for the UE 510 of a wireless system, includes a memory interface to send or receive, to or from a data storage device, data collection information for a 5G or 6G wireless system. The data collection information includes collected dataset 522 for an ML model 102 or trained ML model 120. The UE 510 also includes processing circuitry communicatively coupled to the memory interface, the processing circuitry to decode a data collection request message to request collection of data during a data collection session (DCS) for the ML model 102 or trained ML model 120 from the base station 508 by the UE 302, the data collection request message including DCS configuration information 516, collect data for the ML model 102 or trained ML model 120 by the UE 302 based on the DCS configuration information 516, where the collected dataset 522 includes one or more measurements 524 of RF signals 528, and a message codec encodes a data collection response message for the base station 508 by the UE 510, the data collection response message including a measurement report 526 with the collected dataset 522 comprising the measurements 524 for the ML model 102 or trained ML model 120. The DCS configuration information 516 may include a set of one or more parameters associated with the DCS or the ML model 102 or trained ML model 120. The UE 510 may also include RF circuitry to send the encoded messages and receive the decoded messages as RF signals 910.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

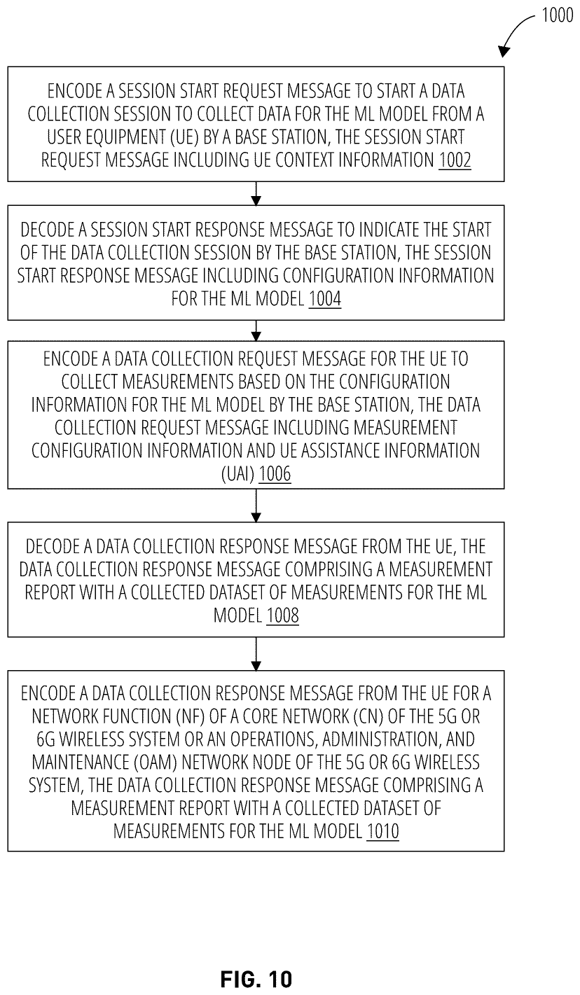

FIG. 10 illustrates an embodiment of a logic flow 1000. The logic flow 1000 may be representative of some or all of the operations executed by one or more embodiments described herein. For example, the logic flow 1000 my include some or all of the operations performed by devices or entities within the functional framework 100, the wireless communication system 200, the wireless communication system 300, the network architecture 400, the data collection system 500, the message flow 600, the message flow 602, the message flow 700, the message flow 702, the message flow 800, the message flow 802, the 3GPP system 900 or any UE operable therein. More particularly, the logic flow 1000 illustrates the base station 508 initiating a data collection session 514 for a UE 510 to collect AI/ML related data. Embodiments are not limited in this context.

In block 1002, logic flow 1000 performs encoding a session start request message to start a data collection session to collect data for a machine learning (ML) model from a user equipment (UE) by a base station of a wireless system, the session start request message including UE context information. In block 1004, logic flow 1000 performs decoding a session start response message to indicate the start of the data collection session by the base station, the session start response message including configuration information for the ML model. In block 1006, logic flow 1000 performs encoding a data collection request message for the UE to collect measurements based on the configuration information for the ML model by the base station, the session activation message including measurement configuration information and UE assistance information (UAI). In block 1008, logic flow 1000 performs decoding a data collection response message comprising a measurement report from the UE, the measurement report includes a collected dataset including measurements for the ML model. In block 1010, logic flow 1000 performs encoding a data collection response message from the UE for a network function (NF) of a core network (CN) of the 5G or 6G wireless system or an operations, administration, and maintenance (OAM) network node of the 5G or 6G wireless system, the data collection response message comprising a measurement report with a collected dataset of measurements for the ML model.

By way of example, the message codec 902 of the base station 508 encodes a session start request message to start a data collection session 514 to collect data for an ML model 102 or trained ML model 120 from a UE 510. The session start request message includes UE context information. The message codec 902 of base station 508 decodes a session start response message to indicate the start of the data collection session 514. The session start response message includes DCS configuration information 516 for the ML model 102 or trained ML model 120. The message codec 902 of the base station 508 encodes a data collection request message for the UE 510 to collect measurements 524 based on the DCS configuration information 516 for the ML model 102 or trained ML model 120. The session activation message includes measurement configuration information and UE assistance information (UAI). The message codec 902 of the base station 508 decodes a data collection response message comprising a measurement report 526 from the UE 510, the measurement report 526 to include a collected dataset 522 including measurements 524 for the ML model 102 or trained ML model 120. The message codec 902 of the base station 508 encodes a data collection response message from the UE 510 for a NF of a CN 608 of the 5G or 6G wireless system or an OAM 606 of the 5G or 6G wireless system. The data collection response message comprises a measurement report 526 with a collected dataset 522 of measurements 524 for the ML model 102 or trained ML model 120.

In some embodiments, the message codec 902 of the base station 508 encodes the session start request message for a NF of a CN 608 of the 5G or 6G wireless system, and decodes the session start response message from the NF of the CN 608.

In some embodiments, the message codec 902 of the base station 508 encodes the session start request message for an OAM 606 of the 5G or 6G wireless system, and decodes the session start response message from the OAM 606.

In some embodiments, the message codec 902 of the base station 508 decodes an initial context setup request message or a handover request message from a NF of a CN 608 of the wireless system.

In some embodiments, the base station 508 comprises a gNB 304 divided into a gNB-CU-CP 306 and a gNB-DU 310, and further the message codec 902 of the base station 508 encodes the session activation request message for the gNB-CU-CP 306 of the gNB 304.

In some embodiments, the data collection session 514 is managed by a collection entity 502 of the wireless system, the collection entity comprising a TCE 504 or an MCE 506.

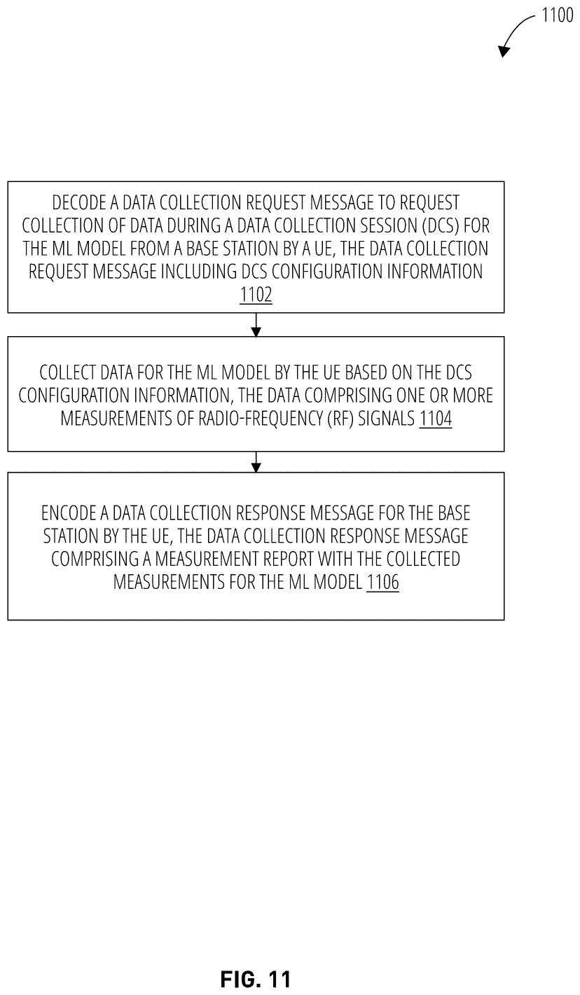

FIG. 11 illustrates an embodiment of a logic flow 1100. The logic flow 1100 may be representative of some or all of the operations executed by one or more embodiments described herein. For example, the logic flow 1100 my include some or all of the operations performed by devices or entities within the functional framework 100, the wireless communication system 200, the wireless communication system 300, the network architecture 400, the data collection system 500, the message flow 600, the message flow 602, the message flow 700, the message flow 702, the message flow 800, the message flow 802, the 3GPP system 900 or any UE operable therein. More particularly, the logic flow 1100 illustrates the base station 508 initiating a data collection session 514 for a UE 510 to collect AI/ML related data. Embodiments are not limited in this context.

In block 1102, logic flow 1100 performs decoding a data collection request message to request collection of data during a data collection session (DCS) for a ML model from a base station, the data collection request message including DCS configuration information. In block 1104, logic flow 1100 performs collecting data for the ML model by the UE based on the DCS configuration information, where the collected dataset includes one or more measurements of RF signals. In block 1106, logic flow 1100 performs encoding a data collection response message for the base station by the UE, the data collection response message including a measurement report with the collected dataset comprising the measurements for the ML model.

By way of example, the UE 510 of a wireless system, includes a memory interface to send or receive, to or from a data storage device, data collection information for a 5G or 6G wireless system. The data collection information includes collected dataset 522 for an ML model 102 or trained ML model 120. The UE 510 also includes processing circuitry communicatively coupled to the memory interface, the processing circuitry to decode a data collection request message to request collection of data during a data collection session (DCS) for the ML model 102 or trained ML model 120 from the base station 508 by the UE 302, the data collection request message including DCS configuration information 516, collect data for the ML model 102 or trained ML model 120 by the UE 302 based on the DCS configuration information 516, where the collected dataset 522 includes one or more measurements 524 of RF signals 528, and a message codec encodes a data collection response message for the base station 508 by the UE 510, the data collection response message including a measurement report 526 with the collected dataset 522 comprising the measurements 524 for the ML model 102 or trained ML model 120. The DCS configuration information 516 may include a set of one or more parameters associated with the DCS or the ML model 102 or trained ML model 120. The UE 510 may also include RF circuitry to send the encoded messages and receive the decoded messages as RF signals 910.

In various embodiments, a specific implementation may have different settings for a DCS. For example, in the NW-side data collection related to beam management use cases, RAN2 may implement gNB-centric and/or OAM-centric approaches. In some embodiments, the same measurement framework is applied to both gNB-centric data collection and OAM-centric data collection for NW-side data collection. Further, RAN2 supports enhancements to MDT for data collection framework for training. It is optional whether to enhance logged or immediate MDT.

In various embodiments, for beam management, for gNB centric and OAM centric (e.g., for RRC signaling between UE and gNB), reporting multiple instances of logged L1 measurement result from UE to gNB via a RRC message as configured by gNB is an optional feature. FFS how to handle case when single RRC message is not sufficient. It is optional if there will be any further enhancement needed pending RANI agreement. Immediate MDT is the baseline framework for OAM-centric data collection for the training of a network-sided model. Enhance the immediate MDT framework to support periodical reporting is considered. It is optional whether and what event-based reporting is supported and FFS on network request reporting.

In various embodiments, as a baseline approach, the UE receives the measurement configuration for AI/ML-enabled features/FGs for data collection and logging of measurements. The network can explicitly configure the UE whether the corresponding data collection and logging (if supported) should be immediately started. It is optional if multiple configurations can be provided to the UE. It is optional if dynamic activation/deactivation is supported. UE stores the logged training data at AS layer with a minimum AS layer memory size supported by the UE. It is optional on the memory size. This is across all use cases. When UE reaches its buffer limitation the UE stops measurement for data collection purposes and logging. Measurements for data collection purposes and logging based can be controlled based on power state of the UE. It is up to UE implementation how the UE determines power state. It is optional whether the UE stops autonomously or if it reports to the network. It is optional whether AS buffer event based reporting is supported. It is optional if availability indication or full report is sent if it is supported. It is optional on event based data collection/logging. On-demand request from the network is supported. It is optional for using different types of signaling.

In various embodiments, the UE implementation can determine how many entries to include in the list radio measurements information, such that the maximum PDCP SDU size is not exceeded. No standardized RRC segmentation procedure is needed (as for the logged MDT measurements). A data collection report will not be transmitted over SRB1. It is optional which SRB is used.

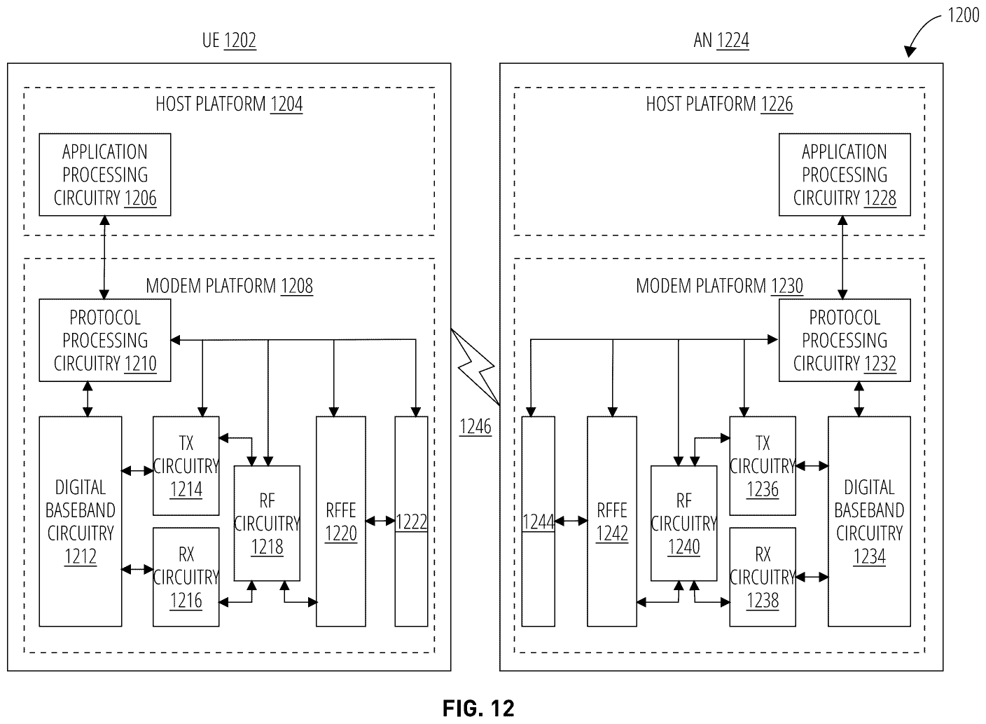

FIG. 12 schematically illustrates a wireless network 1200 in accordance with various embodiments. The wireless network 1200 may include a UE 1202 in wireless communication with an AN 1224. The UE 1202 and AN 1224 may be similar to, and substantially interchangeable with, like-named components described elsewhere herein.

The UE 1202 may be communicatively coupled with the AN 1224 via connection 1246. The connection 1246 is illustrated as an air interface to enable communicative coupling, and can be consistent with cellular communications protocols such as an LTE protocol, a 5G NR, or a 6G protocol operating at mmWave or sub-6 GHz frequencies.

The UE 1202 may include a host platform 1204 coupled with a modem platform 1208. The host platform 1204 may include application processing circuitry 1206, which may be coupled with protocol processing circuitry 1210 of the modem platform 1208. The application processing circuitry 1206 may run various applications for the UE 1202 that source/sink application data. The application processing circuitry 1206 may further implement one or more layer operations to transmit/receive application data to/from a data network. These layer operations may include transport (for example UDP) and Internet (for example, IP) operations

The protocol processing circuitry 1210 may implement one or more of layer operations to facilitate transmission or reception of data over the connection 1246. The layer operations implemented by the protocol processing circuitry 1210 may include, for example, MAC, RLC, PDCP, RRC and NAS operations.

The modem platform 1208 may further include digital baseband circuitry 1234 that may implement one or more layer operations that are “below” layer operations performed by the protocol processing circuitry 1210 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1208 may further include transmit circuitry 1214, receive circuitry 1216, RF circuitry 1218, and RF front end RFFE 1220, which may include or connect to one or more antenna panels 1222. Briefly, the transmit circuitry 1214 may include a digital-to-analog converter, mixer, intermediate frequency (IF) components, etc.; the receive circuitry 1216 may include an analog-to-digital converter, mixer, IF components, etc.; the RF circuitry 1218 may include a low-noise amplifier, a power amplifier, power tracking components, etc.; RFFE 1220 may include filters (for example, surface/bulk acoustic wave filters), switches, antenna tuners, beamforming components (for example, phase-array antenna components), etc. The selection and arrangement of the components of the transmit circuitry 1214, receive circuitry 1216, RF circuitry 1218, RFFE 1220, and antenna panels 1222 (referred generically as “transmit/receive components”) may be specific to details of a specific implementation such as, for example, whether communication is TDM or FDM, in mm Wave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1210 may include one or more instances of control circuitry (not shown) to provide control functions for the transmit/receive components.

A UE reception may be established by and via the antenna panels 1222, RFFE 1220, RF circuitry 1218, receive circuitry 1216, digital baseband circuitry 1212, and protocol protocol processing circuitry 1210. In some embodiments, the antenna panels 1222 may receive a transmission from the AN 1224 by receive-beamforming signals received by a plurality of antennas/antenna elements of the one or more antenna panels 1222.

A UE transmission may be established by and via the protocol processing circuitry 1210, digital baseband circuitry 1212, transmit circuitry 1214, RF circuitry 1218, RFFE 1220, and antenna panels 1222. In some embodiments, the transmit components of the UE 1202 may apply a spatial filter to the data to be transmitted to form a transmit beam emitted by the antenna elements of the antenna panels 1222.

Similar to the UE 1202, the AN 1224 may include a host platform 1226 coupled with a modem platform 1230. The host platform 1226 may include application processing circuitry 1228 coupled with protocol processing circuitry 1232 of the modem platform 1230. The modem platform 1230 may further include digital baseband circuitry 1234, transmit circuitry 1236, receive circuitry 1238, RF circuitry 1240, RFFE circuitry 1242, and antenna panels 1244. The components of the AN 1224 may be similar to and substantially interchangeable with like-named components of the UE 1202. In addition to performing data transmission/reception as described above, the components of the host platform 1204 may perform various logical functions that include, for example, RNC functions such as radio bearer management, uplink and downlink dynamic radio resource management, and data packet scheduling.

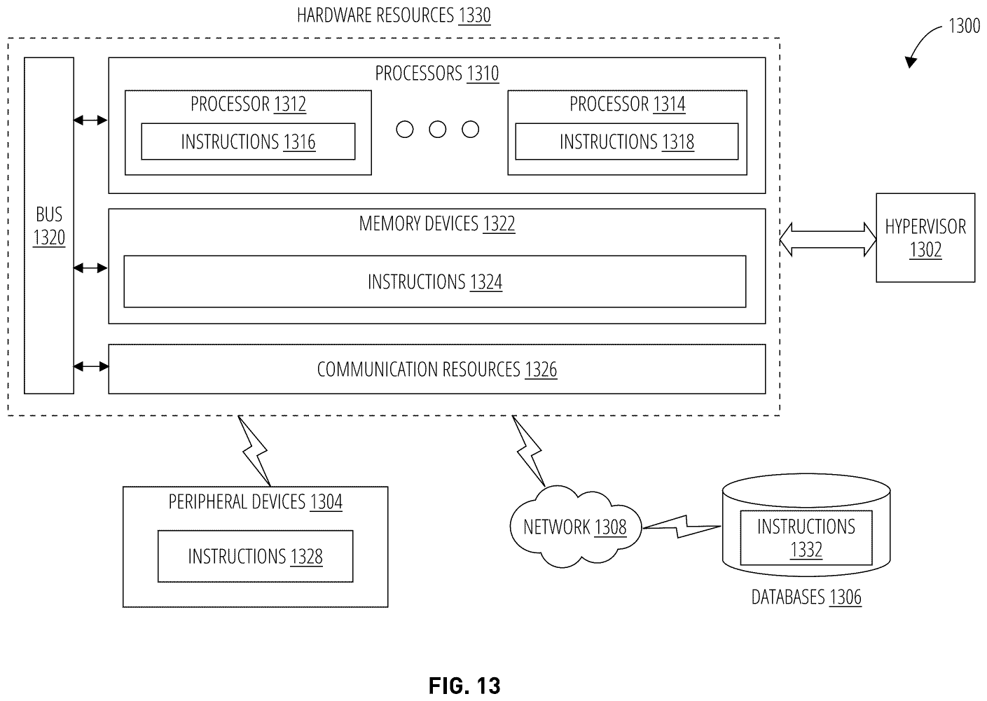

FIG. 13 is a block diagram illustrating an apparatus 1300 with various components, according to some example embodiments, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1330 including one or more processors (or processor cores) 1310, one or more memory devices 1322, and one or more communication resources 1326, each of which may be communicatively coupled via a bus 1320 or other interface circuitry. For embodiments where node virtualization (e.g., NFV) is utilized, a hypervisor 1302 may be executed to provide an execution environment for one or more network slices/sub-slices to utilize the hardware resources 1330.

The processors 1310 may include, for example, a processor 1312 and a processor 1314. The processors 1310 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory devices 1322 (or storage devices) may include main memory, disk storage, or any suitable combination thereof. The memory devices 1322 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1326 may include interconnection or network interface controllers, components, or other suitable devices to communicate with one or more peripheral devices 1304 or one or more databases 1306 or other network elements via a network 2008. For example, the communication resources 1326 may include wired communication components (e.g., for coupling via USB, Ethernet, etc.), cellular communication components, NFC components, Bluetooth® (or Bluetooth® Low Energy) components, Wi-Fi® components, and other communication components.

The instructions 1316, instructions 1318, instructions 1324, instructions 1328, and/or instructions 1332 may comprise software, a program, an application, an applet, an app, or other executable code for causing at least any of the processors 2010 to perform any one or more of the methodologies discussed herein. The instructions 1316, instructions 1318, instructions 1324, instructions 1328, and/or instructions 1332 may reside, completely or partially, within at least one of the processors 1310 (e.g., within the processor's cache memory), the memory devices 1322, or any suitable combination thereof. Furthermore, any portion of the instructions 1316, instructions 1318, instructions 1324, instructions 1328, and/or instructions 1332 may be transferred to the hardware resources 1330 from any combination of the peripheral devices 1304 or the databases 1306. Accordingly, the memory of processors 1310, the memory devices 1322, the peripheral devices 1304, and the databases 1306 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

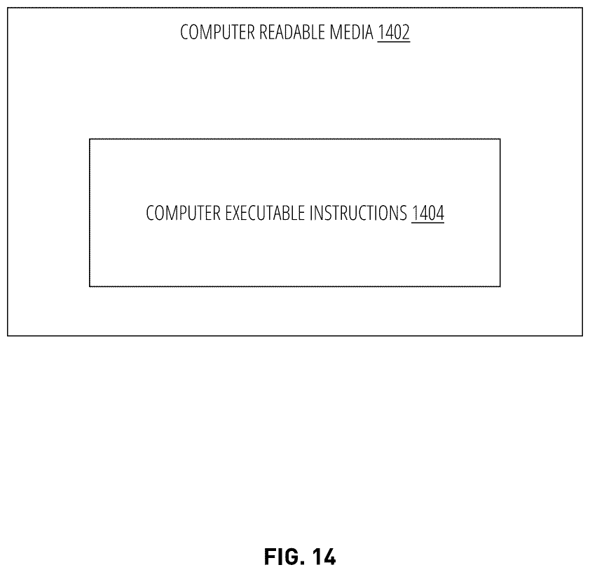

FIG. 14 illustrates a computer readable media 1402. The computer readable media 1402 may store one or more computer executable instructions 1404 to implemented one or more embodiments as described herein. Various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable computer readable media 1402 can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer executable instructions 1404 or computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired net work or direct-wired connection, and wireless media such as acoustic, RF, infrared and other wireless media.

An exemplary storage medium can be coupled to processor, such that processor can read information from, and write information to, the storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the processes and/or actions of a method or algorithm can reside as one or any combination or set of codes and/or instructions on a machine-readable medium and/or computer readable medium, which can be incorporated into a computer program product.

While the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with Al in all products and AI systems. In some embodiments, notices may be provided to users when AI tools are being used to provide features.

### A First Set of Examples

Example 1: A method for collecting AI/ML data from UE to gNB/OAM for model training/model inference and model monitoring purpose.

Example 2: The method of Example 1, whereby the gNB initiates data collection session activation for signaling based and management based data collection.

Example 3: The method of Example 1, whereby the OAM configures a set of assistance information, applicable conditions, use cases, etc for AI/ML data collection, where data collection configuration and assistance information are configured to UE via gNB.

Example 4: The method of Example 1, whereby the gNB provides a preferred set of assistance information, applicable conditions, use cases, etc for AI/ML data collection, requesting session setup for the required data collection.

Example 5: The method of Example 1, whereby the configuration includes logging duration of collected data discontinuously.

Example 6: The method of Example 1, whereby the UE indicates its capability of supporting certain applicable scenario, use cases, etc as part of UE capability or UAI.

Example 7: The method of Example 1, whereby the configuration includes the corresponding effective RRC state.

Example 8: The method of Example 1, whereby the measurement reporting includes the timestamp, duration of collection, condition, assistance information together with reported data.

Example 9: The method of Example 1, whereby gNB setup a data collection session terminated at gNB.

Example 10: The method of Example 1, whereby assistance information, applicable conditions, etc is configured as measurement objects or new object.

Example 11: The method of Example 1, whereby new MTC is considered to configure measurement time duration for AI/ML data collection.

Example 12: The method of Example 1, whereby the gNB configures applicable conditions/scenarios as trigger event, the UE can report buffered data to gNB when environment is changed.

Example 13: The method of Example 1, whereby the gNB configures timer as trigger event, the UE can report buffered data to gNB when timer expires.

Example 14: The method of Example 1, whereby the gNB configures buffer threshold as trigger event, the UE can report buffered data to gNB when the buffer is full.

Example 15: The method of Example 1, whereby the gNB configures quality as trigger event, the UE can report buffered data to gNB when the data met quality threshold.

Example 16: A method for collecting AI/ML data from UE to LMF for model training/model inference and model monitoring purpose.

### A Second Set of Examples

Example 1. An apparatus for an access node of a wireless system, comprising: a memory interface to communicate information associated with a machine learning (ML) model for a fifth generation (5G) or sixth generation (6G) wireless system; and processing circuitry communicatively coupled to the memory interface to: encode a session start request message to start a data collection session (DCS) to collect data for the ML model from a user equipment (UE) by a base station, the session start request message including UE context information; decode a session start response message to indicate the start of the DCS by the base station, the session start response message including DCS configuration information; and encode a data collection request message for the UE to collect measurements for the ML model based on the DCS configuration information by the base station.

Example 2. The apparatus of example 1, comprising: encode the data collection request message for the UE to collect measurements for the ML model based on the DCS configuration information by the base station, the data collection request message including measurement configuration information and UE assistance information (UAI); and decode a data collection response message from the UE, the data collection response message comprising a measurement report with the collected measurements for the ML model.

Example 3. The apparatus of example 1, comprising encode a data collection response message comprising a measurement report from the UE for a network function (NF) of a core network (CN) of the 5G or 6G wireless system or an operations, administration, and maintenance (OAM) network node of the 5G or 6G wireless system, the measurement report message comprising a measurement report with the collected measurements for the ML model.

Example 4. The apparatus of example 1, comprising: encode the session start request message for a network function (NF) of a core network (CN) of the 5G or 6G wireless system; and decode the session start response message from the NF of the CN.

Example 5. The apparatus of example 1, comprising: encode the session start request message for an operations, administration, and maintenance (OAM) network node of the 5G or 6G wireless system; and decode the session start response message from the OAM network node.

Example 6. The apparatus of example 5, comprising decode an initial context setup request message or a handover request message from a network function (NF) of a core network (CN) of the 5G or 6G wireless system.

Example 7. The apparatus of example 1, wherein the base station comprises a gNodeB (gNB) divided into a gNB centralized unit (CU) control plane (CP) (gNB-CU-CP) and a gNB distributed unit (DU) (gNB-DU), further comprising encode the session activation request message for the gNB-CU-CP of the gNB by the gNB-DU.

Example 8. The apparatus of example 1, wherein the data collection session is managed by a collection entity of the 5G or 6G wireless system, the collection entity comprising a trace collection entity (TCE) or a measurement collection entity (MCE).

Example 9. The apparatus of example 1, wherein the data collection session is managed by a collection entity of the 5G or 6G wireless system, the collection entity comprising part of a network function (NF) of a core network (CN) of the 5G or 6G wireless system, an operations, administration, and maintenance (OAM) network node of the 5G or 6G wireless system, or the base station.

Example 10. The apparatus of example 1, comprising radio-frequency (RF) circuitry to send the encoded messages and receive the decoded messages as RF signals.

Example 11. A method for a base station of a wireless system, comprising: encoding a session start request message to start a data collection session (DCS) to collect data for a machine learning (ML) model from a user equipment (UE) by a base station of a wireless system, the session start request message including UE context information; decoding a session start response message to indicate the start of the DCS by the base station, the session start response message including DCS configuration information; and encoding a data collection request message for the UE to collect measurements for the ML model based on the DCS configuration information by the base station.

Example 12. The method of example 11, comprising: encoding the data collection request message for the UE to collect measurements for the ML model based on the DCS configuration information by the base station, the data collection request message including measurement configuration information and UE assistance information (UAI); and decoding a data collection response message comprising a measurement report from the UE, the measurement report comprising a collected dataset including the measurements for the ML model.

Example 13. The method of example 11, comprising: encoding the session start request message for a network function (NF) of a core network (CN) of the 5G or 6G wireless system; and decoding the session start response message from the NF of the CN.

Example 14. The method of example 11, comprising: encoding the session start request message for an operations, administration, and maintenance (OAM) network node of the 5G or 6G wireless system; and decoding the session start response message from the OAM network node.

Example 15. The method of example 11, comprising decoding an initial context setup request message or a handover request message from a network function (NF) of a core network (CN) of the wireless system.

Example 16. The method of example 11, wherein the base station comprises a gNodeB (gNB) divided into a gNB centralized unit (CU) control plane (CP) (gNB-CU-CP) and a gNB distributed unit (DU) (gNB-DU), further comprising encode the session activation request message for the gNB-CU-CP of the gNB by the gNB-DU.

Example 17. The apparatus of example 11, wherein the data collection session is managed by a collection entity of the wireless system, the collection entity comprising a trace collection entity (TCE) or a measurement collection entity (MCE).

Example 18. An apparatus for a user equipment (UE) of a wireless system, comprising:
a memory interface to communicate information associated with a machine learning (ML) model of a fifth generation (5G) or sixth generation (6G) wireless system; and processing circuitry communicatively coupled to the memory interface to: decode a data collection request message to request collection of data during a data collection session (DCS) for the ML model from a base station by a UE, the data collection request message including DCS configuration information; collect data for the ML model by the UE based on the DCS configuration information, the data comprising one or more measurements of radio-frequency (RF) signals; and encode a data collection response message for the base station by the UE, the data collection response message comprising a measurement report with the collected measurements for the ML model.

Example 19. The apparatus of example 18, wherein the DCS configuration information comprises a set of one or more parameters associated with the DCS or the ML model.

Example 20. The apparatus of example 18, wherein the collected measurements for the ML model comprise training data, inferencing data, or management data for the ML model.

It may be appreciated that any of the above examples may be implemented as means plus function and machine-readable media examples. Embodiments are not limited to these examples.

What is claimed is:

1. An apparatus for an access node of a wireless system, comprising:
a memory interface to communicate information associated with a machine learning (ML) model for a fifth generation (5G) or sixth generation (6G) wireless system; and
processing circuitry communicatively coupled to the memory interface to:
encode a session start request message to start a data collection session (DCS) to collect data for the ML model from a user equipment (UE) by a base station, the session start request message including UE context information;
decode a session start response message to indicate the start of the DCS by the base station, the session start response message including DCS configuration information; and
encode a data collection request message for the UE to collect measurements for the ML model based on the DCS configuration information by the base station.

2. The apparatus of claim 1, comprising:
encode the data collection request message for the UE to collect measurements for the ML model based on the DCS configuration information by the base station, the data collection request message including measurement configuration information and UE assistance information (UAI); and
decode a data collection response message from the UE, the data collection response message comprising a measurement report with the collected measurements for the ML model.

3. The apparatus of claim 1, comprising:
encode a data collection response message comprising a measurement report from the UE for a network function (NF) of a core network (CN) of the 5G or 6G wireless system or an operations, administration, and maintenance (OAM) network node of the 5G or 6G wireless system, the measurement report including the collected measurements for the ML model.

4. The apparatus of claim 1, comprising:
encode the session start request message for a network function (NF) of a core network (CN) of the 5G or 6G wireless system; and
decode the session start response message from the NF of the CN.

5. The apparatus of claim 1, comprising:
encode the session start request message for an operations, administration, and maintenance (OAM) network node of the 5G or 6G wireless system; and
decode the session start response message from the OAM network node.

6. The apparatus of claim 5, comprising decode an initial context setup request message or a handover request message from a network function (NF) of a core network (CN) of the 5G or 6G wireless system.

7. The apparatus of claim 1, wherein the base station comprises a gNodeB (gNB) divided into a gNB centralized unit (CU) control plane (CP) (gNB-CU-CP) and a gNB distributed unit (DU) (gNB-DU), further comprising encode the session start request message for the gNB-CU-CP of the gNB by the gNB-DU.

8. The apparatus of claim 1, wherein the data collection session is managed by a collection entity of the 5G or 6G wireless system, the collection entity comprising a trace collection entity (TCE) or a measurement collection entity (MCE).

9. The apparatus of claim 1, wherein the data collection session is managed by a collection entity of the 5G or 6G wireless system, the collection entity comprising part of a network function (NF) of a core network (CN) of the 5G or 6G wireless system, an operations, administration, and maintenance (OAM) network node of the 5G or 6G wireless system, or the base station.

10. The apparatus of claim 1, comprising radio-frequency (RF) circuitry to send the encoded messages and receive the decoded messages as RF signals.

11. A method for a base station of a wireless system, comprising:
encoding a session start request message to start a data collection session (DCS) to collect data for a machine learning (ML) model from a user equipment (UE) by a base station of a wireless system, the session start request message including UE context information;
decoding a session start response message to indicate the start of the DCS by the base station, the session start response message including DCS configuration information; and
encoding a data collection request message for the UE to collect measurements for the ML model based on the DCS configuration information by the base station.

12. The method of claim 11, comprising:
encoding the data collection request message for the UE to collect measurements for the ML model based on the DCS configuration information by the base station, the data collection request message including measurement configuration information and UE assistance information (UAI); and
decoding a data collection response message comprising a measurement report from the UE, the measurement report comprising a collected dataset including the measurements for the ML model.

13. The method of claim 11, comprising:
encoding the session start request message for a network function (NF) of a core network (CN) of the 5G or 6G wireless system; and
decoding the session start response message from the NF of the CN.

14. The method of claim 11, comprising:
encoding the session start request message for an operations, administration, and maintenance (OAM) network node of the 5G or 6G wireless system; and
decoding the session start response message from the OAM network node.

15. The method of claim 11, comprising decoding an initial context setup request message or a handover request message from a network function (NF) of a core network (CN) of the wireless system.

16. The method of claim 11, wherein the base station comprises a gNodeB (gNB) divided into a gNB centralized unit (CU) control plane (CP) (gNB-CU-CP) and a gNB distributed unit (DU) (gNB-DU), further comprising encode the session start request message for the gNB-CU-CP of the gNB by the gNB-DU.

17. The apparatus of claim 11, wherein the data collection session is managed by a collection entity of the wireless system, the collection entity comprising a trace collection entity (TCE) or a measurement collection entity (MCE).

18. An apparatus for a user equipment (UE) of a wireless system, comprising:
a memory interface to communicate information associated with a machine learning (ML) model of a fifth generation (5G) or sixth generation (6G) wireless system; and
processing circuitry communicatively coupled to the memory interface to:
decode a data collection request message to request collection of data during a data collection session (DCS) for the ML model from a base station by a UE, the data collection request message including DCS configuration information;
collect data for the ML model by the UE based on the DCS configuration information, the data comprising one or more measurements of radio-frequency (RF) signals; and
encode a data collection response message for the base station by the UE, the data collection response message comprising a measurement report with the collected measurements for the ML model.

19. The apparatus of claim 18, wherein the DCS configuration information comprises a set of one or more parameters associated with the DCS or the ML model.

20. The apparatus of claim 18, wherein the collected measurements for the ML model comprise training data, inferencing data, or management data for the ML model.
